(19) United States
(12) Patent Application Publication
(10) Pub. No.: US 2026/0145069 A1
(43) Pub. Date: May 28, 2026

(54) TASK FILTERING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Ziqi WEI, Shenzhen (CN)

(21) Appl. No.: 19/362,442

(22) Filed: Oct. 19, 2025

Related U.S. Application Data
(63) Continuation of application No. PCT/CN2025/070667, filed on Jan. 6, 2025.

(30) Foreign Application Priority Data
Jan. 19, 2024 (CN) 202410084658.9

(51) Int. Cl. A63F 13/533

(52) U.S. Cl. CPC A63F 13/533

(57) ABSTRACT

A task filtering method performed by an electronic device includes displaying a plurality of candidate tasks on a task filtering interface of a virtual scene, and displaying one or more target tasks in response to a task filtering instruction triggered based on the task filtering interface. The one or more target tasks are obtained by filtering the plurality of candidate tasks based on at least one filtering element, and are configured for being executed by a virtual object in the virtual scene to obtain one or more virtual resources.

### CROSS-REFERENCE TO RELATED APPLICATIONS

This application is a continuation of International Application No. PCT/CN2025/070667, filed on Jan. 6, 2025, which is based upon and claims priority to Chinese Patent Application No. 202410084658.9, filed on Jan. 19, 2024, the entire contents of both of which are incorporated by reference.

### FIELD OF THE TECHNOLOGY

This application relates to the field of Internet technologies, and in particular, to a task filtering method and apparatus, an electronic device, a computer-readable storage medium, and a computer program product.

### BACKGROUND OF THE DISCLOSURE

In a related game, candidate tasks accepted by a virtual object may be displayed in a virtual scene, and the candidate tasks displayed in the virtual scene are displayed in a random manner. To be specific, in the related game, a manner of displaying the candidate tasks is relatively single.

### SUMMARY

In accordance with the disclosure, there is provided a task filtering method performed by an electronic device and including displaying a plurality of candidate tasks on a task filtering interface of a virtual scene, and displaying one or more target tasks in response to a task filtering instruction triggered based on the task filtering interface. The one or more target tasks are obtained by filtering the plurality of candidate tasks based on at least one filtering element, and are configured for being executed by a virtual object in the virtual scene to obtain one or more virtual resources.

Also in accordance with the disclosure, there is provided an electronic device including a memory storing computer-executable instructions or a computer program, and a processor configured to execute the computer-executable instructions or the computer program to display a plurality of candidate tasks on a task filtering interface of a virtual scene, and display one or more target tasks in response to a task filtering instruction triggered based on the task filtering interface. The one or more target tasks are obtained by filtering the plurality of candidate tasks based on at least one filtering element, and are configured for being executed by a virtual object in the virtual scene to obtain one or more virtual resources.

Also in accordance with the disclosure, there is provided a non-transitory computer-readable storage medium storing computer-executable instructions or a computer program that, when executed by a processor, causes an electronic device including the processor to display a plurality of candidate tasks on a task filtering interface of a virtual scene, and display one or more target tasks in response to a task filtering instruction triggered based on the task filtering interface. The one or more target tasks are obtained by filtering the plurality of candidate tasks based on at least one filtering element, and are configured for being executed by a virtual object in the virtual scene to obtain one or more virtual resources.

### BRIEF DESCRIPTION OF THE DRAWINGS

FIG. 1 is a schematic structural diagram of a task filtering system according to an embodiment of this application.

FIG. 2 is a schematic structural diagram of an electronic device according to an embodiment of this application.

FIG. 3 is a schematic flowchart of a task filtering method according to an embodiment of this application.

FIG. 4 is a schematic diagram showing a task filtering interface according to an embodiment of this application.

FIG. 5 is a schematic diagram showing a task filtering interface according to an embodiment of this application.

FIG. 6 is a schematic diagram showing a task filtering interface according to an embodiment of this application.

FIG. 7 is a schematic diagram showing a task filtering interface according to an embodiment of this application.

FIG. 8 is a schematic diagram showing a task filtering interface according to an embodiment of this application.

FIG. 9 is a schematic diagram showing a difficulty control according to an embodiment of this application.

FIG. 10 is a schematic diagram showing a task filtering interface according to an embodiment of this application.

FIG. 11 is a schematic diagram showing a task filtering interface according to an embodiment of this application.

FIG. 12 is a schematic diagram showing a task filtering interface according to an embodiment of this application.

FIG. 13 is a schematic diagram showing a task route according to an embodiment of this application.

FIG. 14 is a schematic diagram showing a task filtering interface according to an embodiment of this application.

FIG. 15 is a schematic diagram showing a task filtering interface according to an embodiment of this application.

FIG. 16 is a schematic flowchart of a task filtering method according to an embodiment of this application.

FIG. 17 is a schematic flowchart of a task filtering method according to an embodiment of this application.

FIG. 18 is a schematic flowchart of a task filtering method according to an embodiment of this application.

### DESCRIPTION OF EMBODIMENTS

To make the objectives, technical solutions, and advantages of embodiments of this application clearer, the following describes the embodiments of this application in further detail with reference to the accompanying drawings. The described embodiments are not to be considered as a limitation to this application. All other embodiments obtained by a person of ordinary skill in the art without creative efforts fall within the scope of this disclosure.

“Some embodiments” involved in the following description describes a subset of all possible embodiments. However, “some embodiments” may be same or different subsets of all the possible embodiments, and may be combined with each other when there is no conflict.

Terms “first,” “second,” and “third” involved in the following description are merely intended to distinguish between similar objects and do not indicate a specific order of the objects. A specific order or sequence of the “first,” “second,” and “third” may be interchanged if permitted, so that the embodiments of this application described herein may be implemented in an order other than the order illustrated or described herein.

In the embodiments of this application, a term “module” or “unit” refers to a computer program having a predetermined function or a part of a computer program, and operates together with other relevant parts to achieve a predetermined objective, and may be all or partially implemented by using software, hardware (e.g., a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in the embodiments of this application are the same as those usually understood by a person skilled in the art. Terms used in the embodiments of this application are merely intended to describe objectives of the embodiments of this application, but are not intended to limit this application.

Before the embodiments of this application are further described in detail, a description is made on nouns and terms in the embodiments of this application, and the nouns and terms in the embodiments of this application are applicable to the following explanations.

(1) An expression “in response to” is configured for representing a condition or status on which one or more to-be-performed operations depend. When the condition or status is met, the one or more operations may be performed immediately or have a set delay. Unless otherwise specified, there is no chronological order between the plurality of to-be-performed operations.

(2) A virtual scene is a virtual scene displayed (or provided) when the application runs on the terminal. The virtual scene may be a simulated environment of the real world, may be a semi-simulated and semi-fictional virtual environment, or may be a purely fictional virtual environment. The virtual scene may be any one of a two-dimensional virtual scene, a 2.5-dimensional virtual scene, or a three-dimensional virtual scene.

For example, the virtual scene may include the sky, the land, and the ocean. The land may include environmental elements such as deserts and cities. A user may control a virtual object to perform an action in the virtual scene, and the action includes but is not limited to: any one of adjusting a body posture, crawling, walking, running, riding, jumping, driving, picking up, shooting, attacking, or throwing. The virtual scene may be a virtual scene displayed from a first-person perspective (for example, the user role-plays a virtual object in the game from the user's own perspective), may be a virtual scene displayed from a third-person perspective (for example, the user follows a virtual object in the game to play), or may be a virtual scene displayed from an aerial view. The perspectives may be switched freely.

(3) A virtual object is a figure of a person or an object that may interact with other persons and/or objects in the virtual scene, or a mobile object in the virtual scene. The mobile object may be a virtual character, a virtual animal, an animation character, or the like, such as a person, an animal, a plant, an oil drum, a wall, or a stone displayed in the virtual scene. The virtual object may be a virtual figure for representing a user in the virtual scene. The virtual scene may include a plurality of virtual objects. Each virtual object has a shape and a volume in the virtual scene, and occupies some space in the virtual scene.

For example, the virtual object may be a user role controlled through operations on the client, may be artificial intelligence (AI) set in a fight in the virtual scene through training, or may be a non-player character (NPC) set in interaction in the virtual scene. A quantity of virtual objects participating in the interaction in the virtual scene may be preset, or may be dynamically determined based on a quantity of clients participating in the interaction.

(4) A client is a program corresponding to a server that provides a local service to a user. In addition to some applications that can only run locally, the client is generally installed on an ordinary user device and needs to cooperate with the server to run. In other words, the client needs a corresponding server and service program in a network to provide a corresponding service. In this way, a specific communication connection needs to be established on the client and a server side, to ensure a normal operation of an application. The client is, for example, a game client.

Embodiments of this application provide a task filtering method, a task filtering apparatus, an electronic device, a computer-readable storage medium, and a computer program product, to filter tasks in a virtual scene, so as to display a to-be-executed task obtained by filtering based on a filtering element. In the embodiments of this application, a manner of displaying candidate tasks can be changed. Compared with the related art, the manner of displaying candidate tasks can be increased.

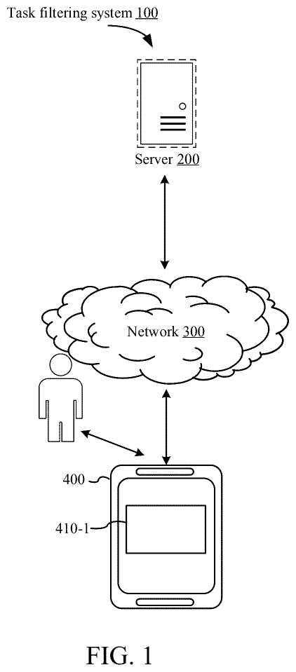

Refer to FIG. 1. FIG. 1 is a schematic structural diagram of a task filtering system according to an embodiment of this application. A task filtering system 100 shown in FIG. 1 is an application scene for implementing task filtering in a virtual scene. A terminal 400 is connected to a server 200 via a network 300. The network 300 may be a wide area network or a local area network, or a combination of both. The terminal 400 and the server 200 may be connected directly or indirectly in a wired or wireless communication manner. This is not limited in this application.

In some embodiments, when a player plays a game, a virtual scene may be displayed on a graphical interface 410-1 of the terminal 400, and a plurality of candidate tasks for selection are displayed on a task filtering interface of the virtual scene. When the player triggers a task filtering instruction, the terminal 400 may transmit the candidate tasks and a task filtering request to the server 200 in response to the task filtering instruction triggered based on the task filtering interface.

The server 200 is configured to receive the candidate tasks and the task filtering request transmitted by the terminal 400, and transmit a to-be-executed task (also referred to as a “target task”) obtained by filtering the plurality of candidate tasks based on at least one filtering element to the terminal 400. The terminal 400 may receive the to-be-executed task obtained by filtering the plurality of candidate tasks based on the at least one filtering element, and display the to-be-executed task on the graphical interface 410-1. The to-be-executed task is obtained by filtering the plurality of candidate tasks based on the at least one filtering element. The to-be-executed task is configured for being executed by a virtual object in the virtual scene to obtain a first virtual resource.

In some embodiments, the server 200 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform.

The terminal 400 may be a user terminal of any type, such as a notebook computer, a tablet computer, a desktop computer, a set-top box, a mobile device (e.g., a mobile phone, a portable music player, a personal digital assistant, a dedicated messaging device, or a portable gaming device), a smartphone, a smart speaker, a smart watch, a smart television, or an in-vehicle terminal.

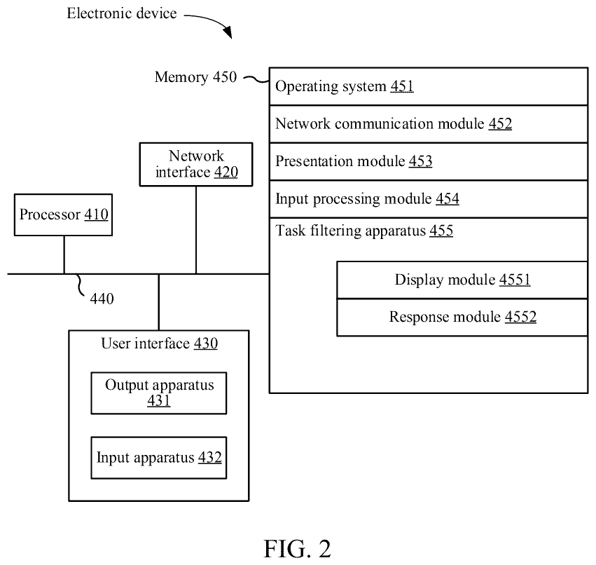

The following describes an electronic device that implements a task filtering method according to an embodiment of this application. The electronic device may be a server or a terminal. Refer to FIG. 2. FIG. 2 is a schematic diagram of a structure of an electronic device according to an embodiment of this application. The electronic device shown in FIG. 2 includes at least one processor 410, a memory 450, at least one network interface 420, and a user interface 430. Components in the electronic device are coupled together by using a bus system 440. The bus system 440 is configured to implement connection and communication between the components. In addition to a data bus, the bus system 440 further includes a power bus, a control bus, and a status signal bus. However, for clarity, various buses are marked as the bus system 440 in FIG. 2.

The processor 410 may be an integrated circuit chip having signal processing capabilities, for example, a general-purpose processor, a digital signal processor (DSP), or another programmable logic device, discrete gate or transistor logic device, or discrete hardware component. The general-purpose processor may be a microprocessor, any conventional processor, or the like.

The user interface 430 includes one or more output apparatuses 431 capable of presenting media content, including one or more loudspeakers and/or one or more visual display screens. The user interface 430 further includes one or more input apparatuses 432, including user interface components that facilitate user input, such as a keyboard, a mouse, a microphone, a touchscreen, a camera, and other input buttons and controls.

The memory 450 may be removable, irremovable, or a combination thereof. Exemplary hardware devices include a solid memory, a hard disk drive, an optical disk drive, and the like. In some embodiments, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in this embodiment of this application is intended to include any suitable types of memories.

In some embodiments, the memory 450 can store data to support various operations. Examples of the data include a program, a module, a data structure, or a subset or a superset thereof, which are described below by way of example.

An operating system 451 includes system programs configured to process various basic system services and perform hardware-related tasks, for example, a framework layer, a core library layer, and a driver layer, which are configured to implement various basic services and process hardware-based tasks.

A network communication module 452 is configured to reach another electronic device through one or more (wired or wireless) network interfaces 420. Exemplary network interfaces 420 include: Bluetooth, wireless fidelity (WiFi), a universal serial bus (USB), and the like.

A presentation module 453 is configured to enable presentation of information via one or more output apparatuses 431 (e.g., a display and a speaker) associated with the user interface 430 (e.g., a user interface for operating a peripheral device and displaying content and information).

An input processing module 454 is configured to detect one or more user inputs or interactions from one of the one or more input apparatuses 432 and translate the detected input or interaction.

In some embodiments, the task filtering apparatus provided in an embodiment of this application may be implemented by software. FIG. 2 shows a task filtering apparatus 455 stored in a memory 450, which may be software in a form of a program and a plug-in, and includes the following software modules: a display module 4551 and a response module 4552. The modules are logical and may be combined in different manners or further split based on to-be-implemented functions. The functions of the modules are to be explained below.

In some other embodiments, the task filtering apparatus provided in an embodiment of this application may be implemented by hardware. As an example, the task filtering apparatus provided in an embodiment of this application may be a processor in the form of a hardware decoding processor, programmed to perform the task filtering method provided in an embodiment of this application. For example, the processor in the form of the hardware decoding processor may use one or more application specific integrated circuits (ASIC), a digital signal processor (DSP), a programmable logic device (PLD), a complex programmable logic device (CPLD), a field-programmable gate array (FPGA), or other electronic components.

In some embodiments, the terminal or the server may implement the task filtering method provided in an embodiment of this application by running various computer-executable instructions or a computer program. For example, the computer-executable instructions may be microprogram-level commands, machine instructions, or software instructions. The computer program may be a native program or a software module in an operating system, may be a native application (APP), namely, a program that needs to be installed in an operating system to run, such as a game APP, or may be a mini program that may be embedded in any APP, namely, a program that only needs to be downloaded into a browser environment to run. To sum up, the computer-executable instructions may be instructions in any form, and the computer program may be an application, a module, or a plug-in in any form.

The following describes the task filtering method provided in an embodiment of this application. In an actual implementation, the task filtering method provided in an embodiment of this application may be independently implemented by a terminal or a server, or may be collaboratively implemented by a terminal and a server.

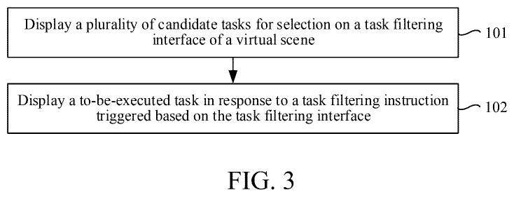

An example in which the terminal 400 in FIG. 1 independently performs the task filtering method provided in an embodiment of this application is used for description below. Refer to FIG. 3. FIG. 3 is a schematic flowchart of a task filtering method according to an embodiment of this application. The task filtering method provided in an embodiment of this application is described with operations shown in FIG. 3.

In operation 101, a plurality of candidate tasks for selection are displayed on a task filtering interface of a virtual scene.

In some embodiments, an application supporting a virtual scene is installed in a terminal. The application may be any one of an open world game, a multiplayer online role-playing game, a first-person shooting game, a third-person shooting game, a multiplayer online battle arena game, a virtual reality application, a three-dimensional map program, or a multiplayer gunfight survival game.

When a user opens the application in the terminal and the terminal runs the application, the terminal presents a picture of the virtual scene. A task control is displayed in the virtual scene. A task filtering interface may be displayed in response to a trigger operation on the task control.

In some embodiments, the task filtering interface corresponding to the virtual scene is displayed, and a virtual object, a movement control, and a skill control are displayed on a task filtering page of the virtual scene. In response to a trigger operation on the movement control, the virtual object may be controlled to move in the virtual scene. In response to a trigger operation on the skill control, the virtual object may be controlled to release a skill in the virtual scene.

In some embodiments, a plurality of candidate tasks for selection may be displayed on the task filtering interface of the virtual scene. In some embodiments, the plurality of candidate tasks for selection may be displayed in a form of a task list. Alternatively, the plurality of candidate tasks for selection may be displayed in a scrolling manner, or certainly may be displayed in a form preset by the user.

For each candidate task, task information of the candidate task may be displayed. The task information includes one or more of a name of the candidate task, description information of the candidate task, a task point of the candidate task, a non-user virtual object corresponding to the candidate task, a fulfillment condition of the candidate task, an executable time period of the candidate task, a virtual resource that may be obtained after the candidate task is executed, a duration needed for executing the candidate task, a type of the candidate task, a route distance from a current position of the virtual object to the task point of the candidate task, a difficulty of the candidate task, and a priority of the candidate task. In this way, the user may intuitively learn information corresponding to the candidate task.

The difficulty of the candidate task may be a preset initial difficulty. The preset initial difficulty of the candidate task may be easy, medium, or hard. The difficulty of the candidate task may further be obtained by calculation according to at least one of information about the virtual object, a prop currently used by the virtual object, or the preset initial difficulty. Correspondingly, the candidate task may have a plurality of difficulty levels according to a calculation result. For example, the difficulty levels may include difficulty level 1 to difficulty level 7. The priorities of the candidate tasks may be set to a plurality of levels according to an actual use requirement, for example, priority 1 to priority 5.

The duration needed for executing the candidate task may be a preset duration. The duration needed for executing the candidate task may further be a duration determined based on at least one of a route distance from the current position of the virtual object to the task point of the candidate task, a prop currently used by the virtual object, information about the virtual object, a preset initial difficulty, or a duration of dialog with a non-user virtual object.

The information about the virtual object may include a prop possessed by the virtual object, a level of the virtual object, a skill of the virtual object, status information of the virtual object, and the like. The prop possessed by the virtual object may be a prop used by the virtual object for releasing a skill, a prop used by the virtual object for changing a movement speed, a prop used by the virtual object for increasing a level, or the like. The status information of the virtual object may include virtual physical strength of the virtual object, a movement speed of the virtual object in the virtual scene, mood of the virtual object, and the like.

The type of the candidate task may include a main task, a side task, a time-limited task, and the like. The main task is a task for promoting development of a game or an activity in the game. The side task is a task other than the main task and is configured for enriching play experience of the user. The time-limited task is a task that may be executed in a preset duration.

The type of the candidate task may further include a candidate task of a type of dialog with the non-user virtual object, a candidate task of a type of collecting virtual resources, a candidate task of exploring the virtual scene, a candidate task of a type of clearing obstacles, a candidate task of a type of using a virtual prop, a candidate task of guiding the user to control the virtual object to perform a particular action type, and the like. This is not limited herein.

The candidate tasks may be tasks that can be accepted and executed by the virtual object controlled by the user in the virtual scene. The candidate tasks may alternatively be tasks delivered by a server for the virtual object. The movement control is configured to control, through interaction, the virtual object to move. The skill control is configured to enable, through interaction, the virtual object to release a skill.

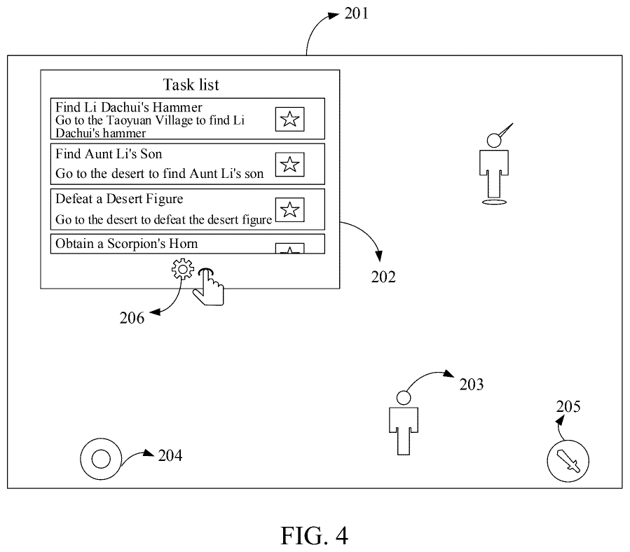

As an example of operation 101, refer to FIG. 4. FIG. 4 is a schematic diagram showing a task filtering interface according to an embodiment of this application. A task list is displayed in a task filtering interface 202 corresponding to a virtual scene 201. FIG. 4 shows only four candidate tasks in the task list. In FIG. 4, a virtual object 203, a movement control 204, and a skill control 205 are further displayed.

Four candidate tasks for selection are displayed in the task filtering interface 202, including a candidate task named “Find Li Dachui's Hammer,” a candidate task named “Find Aunt Li's Son,” a candidate task named “Defeat a Desert Figure,” and a candidate task named “Obtain a Scorpion's Horn.”

For the candidate task named “Find Li Dachui's Hammer,” description information is “Go to the Taoyuan Village to find Li Dachui's hammer.” For the candidate task named “Find Aunt Li's Son,” description information is “Go to the desert to find Aunt Li's son.” For the candidate task named “Defeat a Desert Figure,” description information is “Go to the desert to defeat the desert figure.” For the candidate task named “Obtain a Scorpion's Horn,” description information is “Collect (0/50) scorpions'horns” (not shown in FIG. 4). In this way, the names and description information of the candidate tasks can be displayed. When playing a game, the user may learn the names and description information of the candidate tasks more intuitively.

According to operation 101, a task filtering interface of a virtual scene can be displayed, and a plurality of candidate tasks for selection are displayed on the task filtering interface of the virtual scene, so that a user can conveniently learn the candidate tasks. The candidate tasks are configured for being filtered to obtain a to-be-executed task.

In operation 102, a to-be-executed task is displayed in response to a task filtering instruction triggered based on the task filtering interface.

In some embodiments, the task filtering interface may display a task setting control. In response to a selection operation on the task setting control, a plurality of filtering elements may be displayed on the task filtering interface. The filtering elements may include a task duration, an execution duration, a task distance, a task difficulty, and a task type.

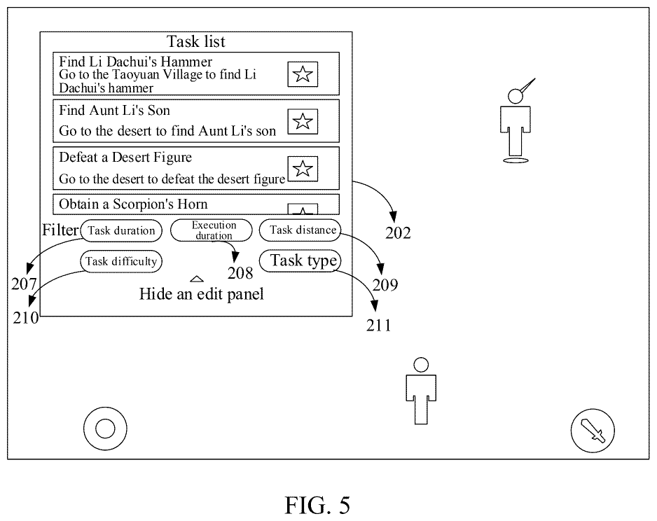

For example, refer to FIG. 4 and FIG. 5. FIG. 5 is a schematic diagram showing a task filtering interface according to an embodiment of this application. In FIG. 4, in response to a trigger operation on a task setting control 206, the interface in FIG. 5 may be displayed. In FIG. 5, a plurality of filtering elements may be displayed on a task filtering interface 202. The filtering elements include a task duration 207, an execution duration 208, a task distance 209, a task difficulty 210, and a task type 211.

The task duration is configured for indicating a duration of each to-be-executed task. The execution duration is configured for indicating a duration corresponding to a to-be-executed task set formed by the to-be-executed tasks, namely for indicating a sum of durations of the to-be-executed tasks in each to-be-executed task set. The task distance is configured for indicating a route distance between a current position of the virtual object and a task point of the to-be-executed task. The task difficulty is configured for indicating a difficulty of the to-be-executed task. The task type is configured for indicating a type of the to-be-executed task.

In response to a selection operation on a first filtering element, a task filtering instruction is received. The first filtering element belongs to a plurality of filtering elements. In response to a task filtering instruction triggered based on a task filtering interface, a to-be-executed task obtained by filtering based on the first filtering element is displayed. In this way, a manner of displaying candidate tasks may be changed. Compared with the related art, the manner of displaying candidate tasks can be increased.

In some embodiments, the task filtering instruction may be a voice instruction given by a user. A to-be-executed task obtained by filtering based on the first filtering element may be displayed in response to the voice instruction triggered based on the task filtering interface. The to-be-executed task is a task obtained by filtering the plurality of candidate tasks based on a filtering element (i.e., the first filtering element) included in the voice instruction. In this way, the user can filter tasks in the virtual scene by using the voice instruction, so as to display the to-be-executed task obtained by filtering. The manner of displaying candidate tasks can be changed, and when playing a game, the user may intuitively learn the to-be-executed task.

In some embodiments, the task filtering instruction may alternatively be a gesture instruction made by the user. Different gesture instructions correspond to different filtering elements. A gesture instruction corresponding to each filtering element may be displayed on the task filtering interface. In response to a gesture instruction triggered based on the task filtering interface, a to-be-executed task obtained by filtering based on a first filtering element may be displayed. The to-be-executed task is a task obtained by filtering a plurality of candidate tasks based on a filtering element (i.e., the first filtering element) corresponding to the gesture instruction. In this way, the user can filter tasks in the virtual scene by using the gesture instruction, so as to display the to-be-executed task obtained by filtering. The manner of displaying candidate tasks can be changed, and when playing a game, the user may intuitively learn the to-be-executed task.

In some embodiments, the task filtering instruction may alternatively be an instruction triggered by the user clicking/tapping a filtering element. The clicking/tapping manner may be a single click/tap, a double click/tap, or the like. This is not limited herein. In response to the user clicking/tapping at least one filtering element displayed on the task filtering interface, the terminal may receive the task filtering instruction. In some embodiments, in response to the user clicking/tapping one filtering element displayed on the task filtering interface, the terminal may receive the task filtering instruction. Alternatively, in some embodiments, in response to the user clicking/tapping a plurality of filtering elements displayed on the task filtering interface, the terminal may receive the task filtering instruction.

To be specific, in response to a selection operation on a first filtering element among a plurality of filtering elements, the terminal may receive a task filtering instruction. After receiving the task filtering instruction, the terminal displays, in response to the task filtering instruction triggered based on the task filtering interface, a to-be-executed task obtained by filtering based on the first filtering element. The to-be-executed task is a task obtained by filtering a plurality of candidate tasks based on the first filtering element. The first filtering element may be one filtering element clicked/tapped by the user, or the first filtering element may be a plurality of filtering elements clicked/tapped by the user. The manner of displaying candidate tasks can be changed, and when playing a game, the user may intuitively learn the to-be-executed task.

In some embodiments, the first filtering element may be identified by using a first display style. The first display style of the first filtering element is different from a display style of another filtering element. In this way, the first filtering element can be distinguished from the another filtering element.

The first display style may be a preset color, a preset font, a preset identifier, or the like. For example, the first filtering element may be identified by using a color different from that of another filtering element. Alternatively, a font of the first filtering element may be magnified. Alternatively, the preset identifier may be added to the first filtering element. Certainly, the first filtering element may alternatively be another display style that can distinguish the first filtering element from another filtering element. This is not limited herein.

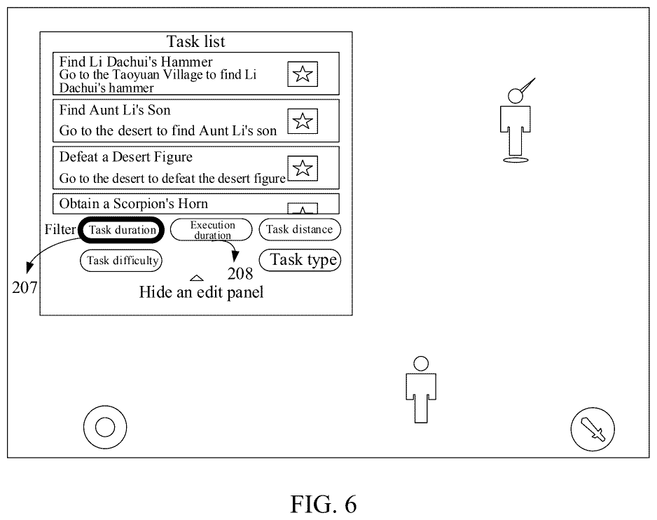

For example, refer to FIG. 6. FIG. 6 is a schematic diagram showing a task filtering interface according to an embodiment of this application. In response to a selection operation for a task duration 207, a frame corresponding to the task duration 207 may be bold (corresponding to a first display style), so that a to-be-executed task obtained by filtering a plurality of candidate tasks based on the task duration 207 may be displayed. In this way, the task duration 207 can be displayed in bold, and the task duration 207 can be distinguished from another filtering element.

The user can filter tasks in the virtual scene by clicking/tapping a filtering element, to display a filtered to-be-executed task. When playing a game, the user may intuitively learn the to-be-executed task.

In some embodiments, an input region of at least one filtering element is displayed on the task filtering interface. The task filtering instruction may alternatively be triggered by the user performing an input operation in the input region of the filtering element. The input region of the filtering element may include one or more of an input region of a task duration, an input region of an execution duration, an input region of a task distance, an input region of a task difficulty, and an input region of a task type.

Input prompt information for the input region is displayed in the input region of the filtering element. In response to a parameter inputted by the user into the input region of the filtering element based on the input prompt information, namely, based on the input prompt information, in response to a parameter input operation for the second filtering element triggered in the first input region, the terminal may receive a task filtering instruction carrying a parameter of a second filtering element. The task filtering instruction carries the parameter of the second filtering element.

In response to the task filtering instruction triggered based on the task filtering interface, a to-be-executed task obtained by filtering based on the parameter of the second filtering element is displayed. The to-be-executed task is a to-be-executed task obtained by filtering a plurality of candidate tasks based on the parameter of the second filtering element. There may be at least one second filtering element. Correspondingly, there may be at least one parameter of the second filtering element.

In a case that the second filtering element includes a task duration, the parameter of the second filtering element may be a duration. In a case that the second filtering element includes an execution duration, the parameter of the second filtering element may be a duration. In a case that the second filtering element includes a task distance, the parameter of the second filtering element may be a distance. In a case that the second filtering element includes a task difficulty, the parameter of the second filtering element may be a parameter indicating a difficulty level. In a case that the second filtering element includes a task type, the parameter of the second filtering element may be a parameter indicating the task type.

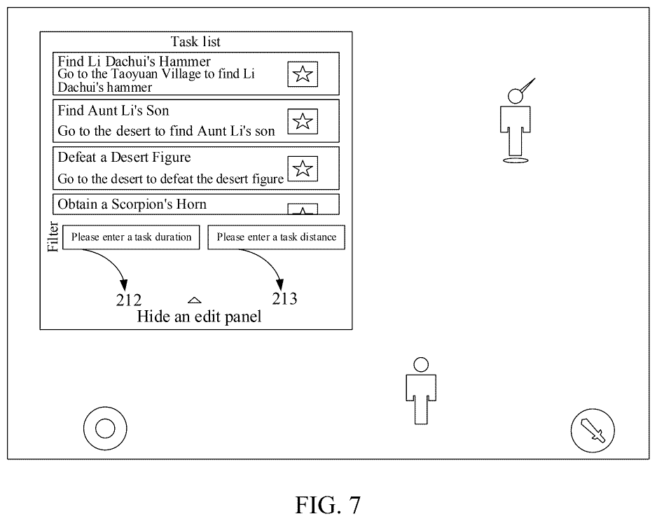

For example, refer to FIG. 7. FIG. 7 is a schematic diagram showing a task filtering interface according to an embodiment of this application. FIG. 7 shows only two filtering element input regions, namely a task duration input region 212 and a task distance input region 213. Input prompt information “Please enter a task duration” for the task duration input region 212 is displayed in the task duration input region 212. Input prompt information “Please enter a task distance” for the task distance input region 213 is displayed in the task distance input region 213.

Based on the input prompt information “Please enter a task duration,” in response to a parameter input operation of the task duration triggered in the task duration input region 212, a to-be-executed task obtained by filtering based on the parameter of the task duration may be displayed. The to-be-executed task is obtained by filtering a plurality of candidate tasks based on the parameter of the second filtering element.

The user can filter tasks in the virtual scene by inputting parameters of filtering elements, to display a to-be-executed task obtained by filtering based on a parameter of a second filtering element. The displayed to-be-executed task meets a use requirement of the user, accuracy of the displayed to-be-executed task is improved, and a manner of displaying candidate tasks can be changed.

The following describes a case that a plurality of candidate tasks are filtered based on different filtering elements to obtain a to-be-executed task. “Displaying a to-be-executed task” in the foregoing operation 102 includes one or more of a first filtering manner to a fifth filtering manner.

In the first filtering manner, in a case that the filtering element is a task duration, a to-be-executed task obtained by filtering based on the task duration is displayed. The to-be-executed task is obtained by filtering a plurality of candidate tasks based on the task duration. The task duration is configured for limiting a duration of each to-be-executed task.

For the first filtering manner, in some embodiments, the duration of the to-be-executed task may be less than the task duration. In some embodiments, the duration of the to-be-executed task may be equal to the task duration. In some embodiments, the duration of the to-be-executed task may be greater than the task duration. In some embodiments, the task duration includes a first task duration and a second task duration. The first task duration is less than the second task duration. The duration of the to-be-executed task is greater than the first task duration, and the duration of the to-be-executed task is less than the second task duration. This may be set according to an actual use requirement of the user. By using the first filtering manner, tasks can be filtered based on the task duration, so that the to-be-executed task filtered based on the task duration may be displayed.

In the second filtering manner, in a case that the filtering element is an execution duration, a to-be-executed task set (also referred to as a “target task set”) obtained by filtering based on the execution duration is displayed. The to-be-executed task set includes at least one to-be-executed task. To be specific, the to-be-executed task set may include one to-be-executed task, or the to-be-executed task set may include a plurality of to-be-executed tasks. The to-be-executed task set is obtained by filtering a plurality of candidate tasks based on the execution duration. The execution duration is configured for limiting a sum of durations of the to-be-executed tasks in each to-be-executed task set.

For the second filtering manner, in some embodiments, the sum of durations of the to-be-executed tasks in each to-be-executed task set may be less than the execution duration. In some embodiments, the sum of durations of the to-be-executed tasks in each to-be-executed task set may be equal to the execution duration. In some embodiments, the sum of durations of the to-be-executed tasks in each to-be-executed task set may be greater than the execution duration.

In some embodiments, the execution duration includes a first execution duration and a second execution duration. The first execution duration is less than the second execution duration. The sum of durations of the to-be-executed tasks in each to-be-executed task set is greater than the first execution duration. The sum of durations of the to-be-executed tasks in each to-be-executed task set is less than the second execution duration. This may be set according to an actual use requirement of the user.

In some embodiments, the to-be-executed tasks may be combined into a plurality of to-be-executed task sets according to the execution duration and the durations of the to-be-executed tasks. In some embodiments, all to-be-executed tasks may be used as one set. A to-be-executed task set may be obtained by deleting a to-be-executed task with a minimum duration until the durations of the remaining to-be-executed tasks is less than or equal to the execution duration. By using the second filtering manner, a plurality of candidate tasks can be grouped (corresponding to the to-be-executed task sets), and the tasks can be filtered based on the execution duration, so that the to-be-executed task set obtained by filtering based on the execution duration may be displayed.

In the third filtering manner, in a case that the filtering element is a task distance, a to-be-executed task obtained by filtering based on the task distance is displayed. The to-be-executed task is obtained by filtering a plurality of candidate tasks based on the task distance. The task distance is configured for indicating a route distance between a current position of the virtual object and a task point of the to-be-executed task.

For the third filtering manner, in some embodiments, the route distance between the current position of the virtual object and the task point of each to-be-executed task is less than the task distance. In some embodiments, the route distance between the current position of the virtual object and the task point of each to-be-executed task is equal to the task distance. In some embodiments, the route distance between the current position of the virtual object and the task point of each to-be-executed task is greater than the task distance.

In some embodiments, when the filtering element is a task distance, displaying the to-be-executed task obtained by filtering based on the task distance may be implemented by: displaying a plurality of distance range options, different distance range options corresponding to different distance ranges. A quantity of the distance ranges may be set according to an actual use requirement. In some embodiments, a plurality of distance range options corresponding to the task distance may be displayed in response to a selection operation for the task distance.

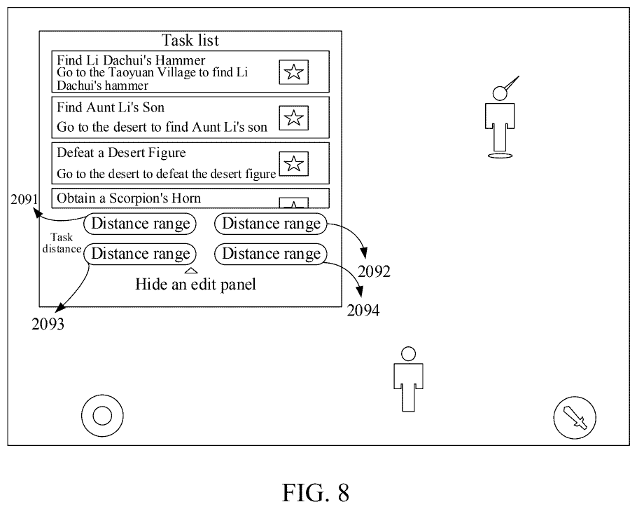

For example, refer to FIG. 8. FIG. 8 is a schematic diagram showing a task filtering interface according to an embodiment of this application. FIG. 8 shows only four distance range options: a distance range 2091, a distance range 2092, a distance range 2093, and a distance range 2094. Distance ranges corresponding to the distance range 2091, the distance range 2092, the distance range 2093, and the distance range 2094 are different.

In response to a selection instruction for a first distance range option among the plurality of distance range options, a to-be-executed task obtained by filtering based on a first distance range is displayed. The to-be-executed task is obtained by filtering a plurality of candidate tasks based on the first distance range. The first distance range option belongs to the plurality of distance range options. The first distance range corresponds to the first distance range option. A route distance between a task point corresponding to the to-be-executed task and a current position of the virtual object is within the first distance range. In this way, the to-be-executed task corresponding to the first distance range can be filtered.

In some embodiments, before the to-be-executed task obtained by filtering based on the first distance range is displayed in response to the selection instruction for the first distance range option, a first distance range corresponding to each distance range option may be displayed. The plurality of distance range options include the first distance range. To be specific, the first distance range corresponding to the first distance range option may be displayed.

A second distance range corresponding to the first distance range option is displayed in response to an adjustment instruction for the first distance range. The second distance range is obtained by adjusting the first distance range based on the adjustment instruction. Then, a to-be-executed task obtained by filtering based on the second distance range is displayed in response to a selection instruction for the first distance range option. In this way, the user may adjust, according to an actual use requirement, a distance range corresponding to a distance range option, so as to filter a to-be-executed task meeting the use requirement of the user.

In the fourth filtering manner, in a case that the filtering element is a task difficulty, a to-be-executed task obtained by filtering based on the task difficulty is displayed. The to-be-executed task is obtained by filtering a plurality of candidate tasks based on the task difficulty. For the fourth filtering manner, in some embodiments, filtering may be performed based on a preset initial difficulty of candidate tasks. For example, a to-be-executed task obtained by filtering is a task among the candidate tasks, where the task difficulty of the task is easy. In some embodiments, a difficulty of each to-be-executed task may be calculated according to at least one of information about the virtual object or a preset initial difficulty of a prop currently used by the virtual object.

For example, the difficulty of each candidate task may be calculated according to the information about the virtual object. For another example, the difficulty of each candidate task may be calculated according to the prop currently used by the virtual object. For another example, the difficulty of each candidate task may be calculated according to the information about the virtual object, the prop of the virtual object, and the initial difficulty. In this way, a more precise task difficulty may be obtained.

In some embodiments, the difficulty of the to-be-executed task may be less than the task difficulty. In some embodiments, the difficulty of the to-be-executed task may be equal to the task difficulty. In some embodiments, the difficulty of the to-be-executed task may be greater than the task difficulty. In some embodiments, the task difficulty includes a first task difficulty and a second task difficulty. The second task difficulty is less than the first task difficulty. The difficulty of the to-be-executed task is greater than the first task difficulty, and the difficulty of the to-be-executed task is less than the second task difficulty. This may be set according to an actual use requirement of the user. By using the fourth filtering manner, tasks can be filtered based on the task difficulty, so that the to-be-executed task obtained by filtering based on the task difficulty may be displayed.

In the fifth filtering manner, in a case that the filtering element is a task type, a to-be-executed task obtained by filtering based on the task type is displayed. The to-be-executed task is obtained by filtering a plurality of candidate tasks based on the task type. For the fifth filtering manner, in some embodiments, the to-be-executed task may be a task of one type among the candidate tasks. For example, the to-be-executed task obtained by filtering may be a task among the candidate tasks, where the task type of the task is a side task.

In some embodiments, the to-be-executed task obtained by filtering may be tasks of a plurality of types among the candidate tasks. For example, the to-be-executed task may be a task among the candidate tasks, where the task type of the task is dialog with a non-user virtual object. In addition, the to-be-executed task may be a task, where the task type of the task is collecting virtual resources. This may be set according to an actual use requirement. By using the fifth filtering manner, tasks can be filtered based on the task type, so that the to-be-executed task obtained by filtering based on the task type may be displayed.

In some embodiments, in a case that a plurality of candidate tasks are filtered based on only one filtering element to obtain a to-be-executed task, any one of the first filtering manner to the fifth filtering manner may be performed. For example, if the task type is a side task, the fifth filtering manner may be performed. To be specific, to-be-executed task 1 obtained by filtering a plurality of candidate tasks based on the side task is displayed. To-be-executed task 1 is a task among the candidate tasks, where the task type of the task is the side task.

In some embodiments, in a case that a plurality of candidate tasks are filtered based on a plurality of filtering elements to obtain a to-be-executed task, a plurality of filtering manners of the first filtering manner to the fifth filtering manner may be performed, to display the to-be-executed task obtained by filtering.

For example, if the task type is a side task and the task duration is 3 min, the first filtering manner and the fifth filtering manner may be performed, to display to-be-executed task 2 obtained by filtering a plurality of candidate tasks based on the task duration and the side task. To-be-executed task 2 is a task, where the task type of the task is the side task and the duration is less than or equal to 3 min. In this way, candidate tasks may be accurately filtered.

In some embodiments, in response to a task filtering instruction triggered based on the task filtering interface, the terminal may transmit at least one filtering element corresponding to the task filtering instruction to the server. To be specific, the terminal may transmit a task filtering request carrying the at least one filtering element to the server. The server may filter a plurality of candidate tasks based on the at least one filtering element, to obtain a to-be-executed task. Then, the server may transmit the to-be-executed task to the terminal. The terminal may display the to-be-executed task obtained by filtering the plurality of candidate tasks based on the at least one filtering element. In this way, the server may transmit only a filtered to-be-executed task to the terminal, so that a data volume of data transmission performed by the server and the terminal can be reduced.

In some embodiments, in response to a task filtering instruction triggered by the task filtering interface, the terminal may only load a to-be-executed task obtained by filtering based on at least one filtering element corresponding to the task filtering instruction. To be specific, the terminal may only load the filtered to-be-executed task, thereby reducing resources consumed for loading the to-be-executed task.

In this embodiment of this application, a plurality of candidate tasks may be filtered by using at least one filtering element: a task duration, an execution duration, a task distance, a task difficulty, and a task type, so that a filtered to-be-executed task may be displayed, and a manner of displaying candidate tasks can be increased.

In some embodiments, task information of a to-be-executed task may be displayed. The task information includes one or more of: a duration of the to-be-executed task, a type of the to-be-executed task, a distance of route (i.e., a route distance) between a current position of the virtual object and a task point of the to-be-executed task, a difficulty of the to-be-executed task, a priority of the to-be-executed task, a name of the to-be-executed task, the task point of the to-be-executed task, a non-virtual object corresponding to the to-be-executed task, a fulfillment condition of the to-be-executed task, an executable time period of the to-be-executed task, and a virtual resource that may be obtained after the to-be-executed task is executed. In this way, the user can better understand a to-be-executed task.

For descriptions of the difficulty of the to-be-executed task, the duration of the to-be-executed task, and the type of the to-be-executed task, refer to descriptions of the difficulty of the candidate task, the duration of the candidate task, and the type of the candidate task respectively. Details are not described herein again.

The to-be-executed task is configured for being executed by a virtual object in a virtual scene to obtain a first virtual resource. The first virtual resource may be a prop for changing a status of the virtual object, experience for changing a level of the virtual object, an item for the virtual object to purchase a prop, or the like.

In some embodiments, there is at least one execution route for each to-be-executed task. The execution route is a route from a current position of the virtual object to a task point of the corresponding to-be-executed task. The execution route is related to the virtual scene. To be specific, the execution route relates to element routes corresponding to the sky, the land, the ocean, the desert, or the like.

For an element involved in the execution route, the virtual object may reach the task point of the to-be-executed task by crawling, walking, running, riding, jumping, driving, swimming, or flying. In the presence of a plurality of execution routes, the execution routes may have a plurality of difficulties. A quantity of the difficulties is less than or equal to a quantity of the execution routes.

To make it convenient for the user to select a route according to an actual use requirement, after a to-be-executed task is displayed, a plurality of difficulty controls may be displayed. Different difficulty controls correspond to different difficulties of the execution routes.

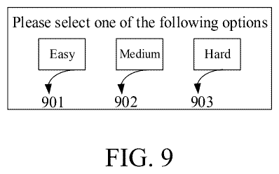

For example, refer to FIG. 9. FIG. 9 is a schematic diagram of a difficulty control according to an embodiment of this application. “Please select one of the following options” is displayed in FIG. 9. The difficulty control includes a difficulty control 901, a difficulty control 902, and a difficulty control 903. The options are the difficulty control 901, the difficulty control 902, and the difficulty control 903. A difficulty of an execution route corresponding to the difficulty control 901 is easy. A difficulty of an execution route corresponding to the difficulty control 902 is medium. A difficulty of an execution route corresponding to the difficulty control 903 is hard.

A first execution route is displayed in response to a trigger operation on a first difficulty control among the plurality of difficulty controls. The first execution route is obtained by filtering based on a difficulty corresponding to the first difficulty control. The first difficulty control belongs to the plurality of difficulty controls. The first execution route may be used by the virtual object to execute corresponding to-be-executed tasks. The first execution route may further be configured for sorting the to-be-executed tasks.

In some embodiments, the first difficulty control may be configured for one to-be-executed task. For each to-be-executed task, the first execution route obtained by filtering based on the difficulty corresponding to the first difficulty control may be displayed in response to a trigger operation for the first difficulty control among the plurality of difficulty controls. In this way, for each to-be-executed task, the user may select a difficulty of an execution route according to an actual use requirement.

In some embodiments, the first difficulty control may be configured for all filtered to-be-executed tasks. In this way, the user only needs to select a difficulty of one execution route according to an actual use requirement, thereby improving interaction efficiency.

In the presence of a plurality of execution routes, routes can be filtered based on difficulties of the execution routes in a manner of displaying a first execution route in response to a trigger operation for a first difficulty control among a plurality of difficulty controls, thereby helping the user to select the first execution route meeting an actual use requirement with different difficulties of the execution routes.

A method for sorting to-be-executed tasks is described below. In some embodiments, in the presence of a plurality of to-be-executed tasks, at least one sorting control may be displayed on the task filtering interface. Each sorting control corresponds to a sorting element. The sorting element is configured for sorting the to-be-executed tasks. To be specific, one or more sorting elements for sorting the to-be-executed tasks are displayed on the task filtering interface.

The sorting element may include a duration of the to-be-executed task, a route distance between a current position of the virtual object and a task point of the to-be-executed task, a difficulty of the to-be-executed task, a type of the to-be-executed task, or a priority of the to-be-executed task.

After a to-be-executed task is displayed, a first to-be-executed task sequence may be displayed in response to a trigger operation for a first sorting control on the task filtering interface. A to-be-executed task sequence is also referred to as a “target task sequence.” The first sorting control corresponds to a first sorting element. The first to-be-executed task sequence is obtained by sorting the plurality of to-be-executed tasks based on the first sorting element. A manner of displaying the first to-be-executed task sequence is described below with reference to a first sorting manner to a fifth sorting manner. The manner of displaying the first to-be-executed task sequence may be any one of the first sorting manner to the fifth sorting manner.

In the first sorting manner, in a case that the sorting element is a duration of the to-be-executed task, a first to-be-executed task sequence obtained by sorting based on the duration of the to-be-executed task is displayed. The first to-be-executed task sequence is obtained by sorting a plurality of to-be-executed tasks based on the duration of the to-be-executed task.

In the second sorting manner, in a case that the sorting element is a route distance, the route distance is a route distance between a current position of the virtual object and a task point of the to-be-executed task. A first to-be-executed task sequence obtained by sorting based on the route distance is displayed. The first to-be-executed task sequence is obtained by sorting a plurality of to-be-executed tasks based on the route distance between the current position of the virtual object and the task point of the to-be-executed task.

In the third sorting manner, in a case that the sorting element is a difficulty of the to-be-executed task, a first to-be-executed task sequence obtained by sorting based on the difficulty of the to-be-executed task is displayed. The first to-be-executed task sequence is obtained by sorting a plurality of to-be-executed tasks based on the difficulty of the to-be-executed task.

In the fourth sorting manner, in a case that the sorting element is a type of the to-be-executed task, a first to-be-executed task sequence obtained by sorting based on the type of the to-be-executed task is displayed. The first to-be-executed task sequence is obtained by sorting a plurality of to-be-executed tasks based on the type of the to-be-executed task.

In the fifth sorting manner, in a case that the sorting element is a priority of the to-be-executed task, a first to-be-executed task sequence obtained by sorting based on the priority of the to-be-executed task is displayed. The first to-be-executed task sequence is obtained by sorting a plurality of to-be-executed tasks based on the priority of the to-be-executed task. The to-be-executed tasks can be sorted in the first sorting manner to the fifth sorting manner.

In some embodiments, the first sorting element may be identified by using a second display style. The second display style is different from a display style of another sorting element. The first sorting element identified by using the second display style is in a selected state, so that the user can intuitively learn the first sorting element for sorting a plurality of to-be-executed tasks.

The second display style may be a preset color, a preset font, a preset identifier, or the like. This is not limited herein. In this way, the user can more intuitively learn the first sorting element for sorting the plurality of to-be-executed tasks.

In some embodiments, after a first to-be-executed task sequence is displayed, a second to-be-executed task sequence is displayed in response to an adjustment instruction for the first to-be-executed task sequence. The second to-be-executed task sequence is obtained by adjusting sorting of a plurality of to-be-executed tasks in the first to-be-executed task sequence.

In some embodiments, the user may click/tap any one to-be-executed task among the plurality of to-be-executed tasks in the first to-be-executed task sequence, and adjust, by dragging, sorting of the plurality of to-be-executed tasks in the first to-be-executed task sequence, so that the second to-be-executed task sequence may be displayed. In this way, the sorting of the plurality of to-be-executed tasks in the first to-be-executed task sequence can be adjusted according to an actual use requirement.

In some embodiments, the user may delete one or more to-be-executed tasks from the first to-be-executed task sequence, and may adjust sorting of the plurality of to-be-executed tasks in the first to-be-executed task sequence, so that the second to-be-executed task sequence may be displayed.

In some embodiments, the user may add a to-be-executed task to any position in the first to-be-executed task sequence, so that the sorting of the plurality of to-be-executed tasks in the first to-be-executed task sequence may be adjusted, thereby displaying the second to-be-executed task sequence.

In some embodiments, one or more of an order control and a reverse order control for adjusting the first to-be-executed task sequence are further displayed on the task filtering interface. In a case that the task filtering interface includes only the order control, in response to a trigger operation for the order control, the order control is in a selected state, and a plurality of to-be-executed tasks sorted based on an order are displayed. In response to a trigger operation for the order control again, the order control is in an unselected state, and a plurality of to-be-executed tasks sorted based on a reverse order are displayed.

The case that the task filtering interface includes only the reverse order control corresponds to the case that the task filtering interface includes only the order control. Refer to the description of the case that the task filtering interface includes only the order control. Details are not described herein again.

In a case that the task filtering interface includes the order control and the reverse order control, in response to a trigger operation for the order control, only the order control is in a selected state, and a plurality of to-be-executed tasks sorted based on an order are displayed. In response to a trigger operation for the reverse order control, only the reverse order control is in a selected state, and a plurality of to-be-executed tasks sorted based on a reverse order are displayed. In this way, sorting based on an order or a reverse order can be performed according to an actual use requirement of the user.

The order control in a selected state and the reverse order control in a selected state may be identified in a third display style. The third display style may be a preset color, a preset font, a preset identifier, or the like. This is not limited herein. In this way, the user can more intuitively learn whether sorting based on an order or a reverse order is performed currently.

In some embodiments, in a case that the first sorting element is a duration of the to-be-executed task, ascending sorting of the durations of the to-be-executed tasks may be an order. Correspondingly, descending sorting of the durations of the to-be-executed tasks may be a reverse order. If the first to-be-executed task sequence is in the order, the second to-be-executed task sequence is in the reverse order.

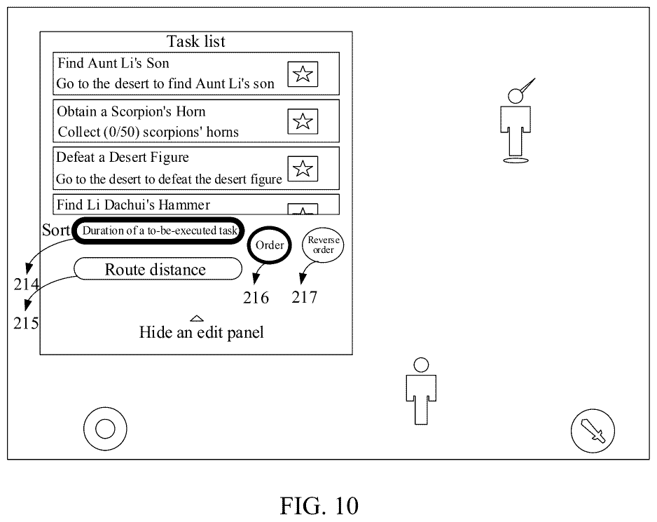

For example, refer to FIG. 10. FIG. 10 is a schematic diagram showing a task filtering interface according to an embodiment of this application. FIG. 10 shows two sorting elements. The sorting elements include a duration 214 of a to-be-executed task and a route distance 215. The route distance 215 is a route distance between a current position of a virtual object and a task point of the to-be-executed task.

FIG. 10 further shows an order control 216 and a reverse order control 217. In response to a trigger operation for the duration 214 of the to-be-executed task and in response to a trigger operation on the order control 216, both the duration 214 of the to-be-executed task and the order control 216 are in a selected state. A plurality of to-be-executed tasks sorted in ascending order based on the duration of the to-be-executed task are displayed. The plurality of to-be-executed tasks are sorted in ascending order based on the duration of the to-be-executed task.

In some embodiments, in a case that the first sorting element is a route distance, the route distance is a route distance between the current position of the virtual object and the task point of the to-be-executed task. Ascending sorting of the route distances between the current position of the virtual object and the task points of the to-be-executed tasks may be an order. Correspondingly, descending sorting of the route distances between the current position of the virtual object and the task points of the to-be-executed tasks may be a reverse order. If the first to-be-executed task sequence is in the order, the second to-be-executed task sequence is in the reverse order.

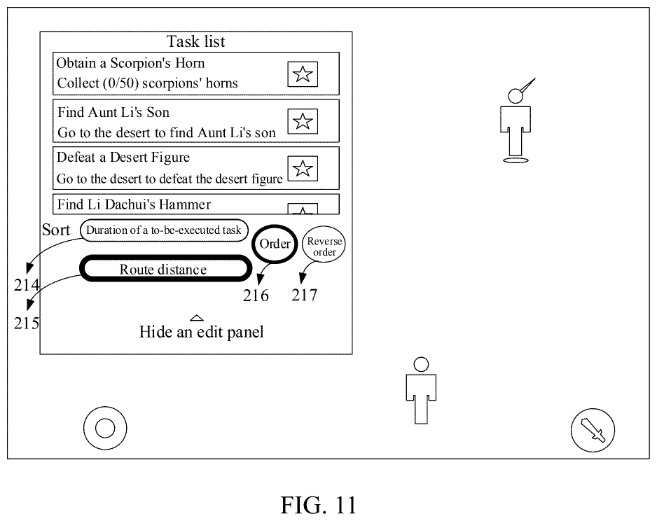

For example, refer to FIG. 11. FIG. 11 is a schematic diagram showing a task filtering interface according to an embodiment of this application. FIG. 11 shows two sorting elements. The sorting elements include a duration 214 of a to-be-executed task and a route distance 215. The route distance 215 is a route distance between a current position of a virtual object and a task point of the to-be-executed task.

FIG. 11 further shows an order control 216 and a reverse order control 217. In response to a trigger operation for the route distance 215 and in response to a trigger operation on the order control 216, both the route distance 215 and the order control 216 are in a selected state. A plurality of to-be-executed tasks sorted in ascending order of the route distances between the current position of the virtual object and the task points of the to-be-executed tasks are displayed.

In some embodiments, in a case that the first sorting element is a difficulty of the to-be-executed task, ascending sorting of the difficulties of the to-be-executed tasks may be an order. Correspondingly, descending sorting of the difficulties of the to-be-executed tasks may be a reverse order. If the first to-be-executed task sequence is in the order, the second to-be-executed task sequence is in the reverse order.

In some embodiments, in a case that the first sorting element is a type of the to-be-executed task, sorting of the types of the to-be-executed tasks based on a preset type order may be an order. Correspondingly, sorting of the types of the to-be-executed tasks based on a reverse order of the preset type order may be a reverse order. If the first to-be-executed task sequence is in the order, the second to-be-executed task sequence is in the reverse order. The plurality of to-be-executed tasks in the first to-be-executed task sequence and the second to-be-executed task sequence are sorted differently.

The preset type order is set according to an actual use requirement of the user. Different preset type orders may be set for types of to-be-executed tasks. For example, the preset type order may be that a main task precedes a side task and a time-limited task precedes the main task.

In some embodiments, in a case that the first sorting element is a priority of the to-be-executed task, ascending sorting of the priorities of the to-be-executed tasks may be an order. Correspondingly, descending sorting of the priorities of the to-be-executed tasks may be a reverse order. If the first to-be-executed task sequence is in the order, the second to-be-executed task sequence is in the reverse order.

In some embodiments, in response to a trigger operation for the first sorting element in the task filtering interface, the terminal may transmit the first sorting element to the server. The server may sort the plurality of to-be-executed tasks based on the first sorting element. Then, the server may transmit the plurality of sorted to-be-executed tasks to the terminal. The terminal may display the plurality of sorted to-be-executed tasks. The plurality of sorted to-be-executed tasks are obtained by sorting the plurality of to-be-executed tasks based on the first sorting element.

In some embodiments, in the presence of a plurality of to-be-executed tasks, recommendation information of the to-be-executed tasks is displayed. The recommendation information is configured for guiding the user to select the to-be-executed task, and the recommendation information includes one or more of a recommendation degree and a recommended prop for the to-be-executed task. In this way, the user can be guided by using the recommendation information to select a to-be-executed task that is more suitable for the virtual object.

The recommendation degree may be obtained by calculation according to one or more of information about the virtual object, a prop currently used by the virtual object, and a difficulty of the to-be-executed task. In some embodiments, the recommendation degree may be recommended or non-recommended. A preset recommendation identifier may be added to a recommended to-be-executed task. A preset recommendation identifier may not be added to a non-recommended to-be-executed task.

In some embodiments, the recommendation degree may include a plurality of recommendation levels. For example, the recommendation levels may include recommendation level 1 to recommendation level 10. Then, the recommendation level may be displayed in an associated region of the to-be-executed task. The associated region of the to-be-executed task is a region corresponding to a preset distance from the to-be-executed task.

In some embodiments, in the presence of a plurality of to-be-executed task sets, recommendation information of the to-be-executed task sets is displayed. The recommendation information of the to-be-executed task sets is configured for guiding the user to select a to-be-executed task set. In this way, the user can be guided to select a to-be-executed task set that is more suitable for the virtual object. Equivalent replacement may be made for descriptions of the recommendation information of the to-be-executed tasks. Details are not described herein again.

A manner of executing a to-be-executed task is described below. In some embodiments, after the plurality of candidate tasks are filtered based on the filtering element to obtain a to-be-executed task, the to-be-executed task may be executed. In some embodiments, in response to a selection operation for a first to-be-executed task set among the to-be-executed task sets, the first to-be-executed task set is controlled to be in a selected state, and at least one to-be-executed task corresponding to the first to-be-executed task set is displayed, so that to-be-executed tasks in the first to-be-executed task set may be executed.

In some embodiments, in response to a selection operation for a first to-be-executed task among the to-be-executed tasks, the first to-be-executed task is controlled to be in a selected state. The first to-be-executed task may be identified by using a fourth display style. The fourth display style may be a preset color, a preset font, a preset identifier, or the like. This is not limited herein. In this way, the user can more intuitively learn a first to-be-executed task currently executed by the virtual object.

A first movement picture is displayed in the virtual scene in response to a task execution instruction. The first movement picture is a picture in which the virtual object moves to a task point corresponding to the first to-be-executed task. In some embodiments, a plurality of execution routes may be displayed in response to a task execution instruction. The execution routes are routes from a current position of the virtual object to a task point corresponding to the first to-be-executed task. The plurality of execution routes may be execution routes obtained by filtering based on the difficulty corresponding to the first difficulty control, or may be execution routes obtained by not filtering based on the difficulty corresponding to the first difficulty control.

A first movement picture is displayed in response to a selection operation for a second execution route among the plurality of execution routes. The first movement picture is a picture in which the virtual object moves to the task point based on the second execution route. In this way, the user only needs to select the second execution route to automatically move the virtual object to the task point.

In some embodiments, the second execution route may be displayed in the virtual scene, and a fourth movement picture may be displayed in response to a control operation of the user for a movement control. The fourth movement picture is a picture in which the virtual object moves based on the control operation. In this way, the second execution route can guide the user to control the virtual object to move to the task point.

In some embodiments, in response to a selection operation for the second execution route among the plurality of execution routes, the terminal may transmit the second execution route to the server. The server may generate a first control parameter for the virtual object according to the second execution route, and transmit the first control parameter to the terminal. The terminal may execute the first control parameter, to display a picture in which the virtual object moves to the task point based on the second execution route. In this way, the virtual object can automatically move to the task point without the need of an operation by the user.

In this embodiment of this application, after tasks are filtered or the tasks are filtered and sorted, the tasks may be executed by selecting a first to-be-executed task by a user, so that efficiency of determining a to-be-executed task can be improved, an actual use requirement of the user can be met, and efficiency of human-computer interaction can be improved.

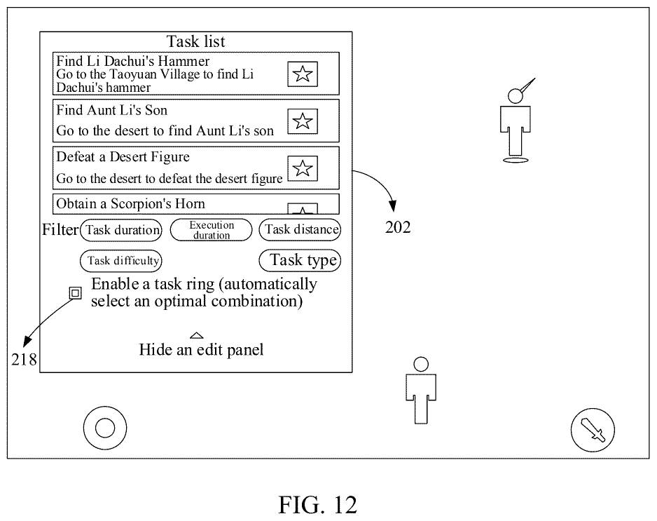

In some embodiments, a combined task control is displayed when a quantity of to-be-executed tasks is a first quantity and the first quantity is greater than 1. For example, refer to FIG. 12. FIG. 12 is a schematic diagram showing a task filtering interface according to an embodiment of this application. A combined task control 218 may be displayed on a task filtering interface 202. Prompt information of the combined task control 218 is “Enable a task ring (automatically select an optimal set).” A combined task may alternatively be referred to as a task ring.

In response to a trigger operation on the combined task control, a task route constructed based on a second quantity of to-be-executed tasks is displayed. The to-be-executed tasks serve as route nodes of the task route. The task route is configured for guiding the virtual object to sequentially fulfill the to-be-executed tasks based on the route nodes. The second quantity is less than or equal to the first quantity.

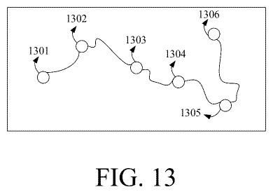

For example, refer to FIG. 13. FIG. 13 is a schematic diagram of a task route according to an embodiment of this application. To-be-executed tasks include six to-be-executed tasks: a to-be-executed task 1301, a to-be-executed task 1302, a to-be-executed task 1303, a to-be-executed task 1304, a to-be-executed task 1305, and a to-be-executed task 1306. The to-be-executed task 1301, the to-be-executed task 1302, the to-be-executed task 1303, the to-be-executed task 1304, the to-be-executed task 1305, and the to-be-executed task 1306 serve as route nodes of the task route.

In a case that a combined task is enabled, the user may control a virtual object to sequentially fulfill a second quantity of to-be-executed tasks based on the route nodes in the task route. The combined task may add consecutive tasks to each task that is being executed in sequence. The user does not need to frequently select a task to be executed, thereby further improving task execution efficiency.

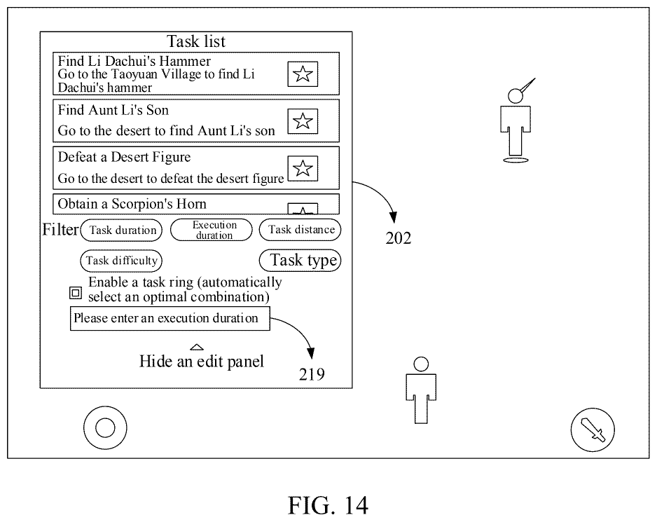

In some embodiments, a setting control is displayed on the task filtering interface. The setting control is configured to set an execution duration. In some embodiments, input prompt information of the setting control may further be displayed. For example, refer to FIG. 14. FIG. 14 is a schematic diagram showing a task filtering interface according to an embodiment of this application. A setting control 219 for setting an execution duration may be displayed on a task filtering interface 202. The setting control 219 displays input prompt information. The input prompt information is “Please enter an execution duration.”

The execution duration of the virtual object is set to a first duration indicated by the setting operation based on the setting control in response to a setting operation for the execution duration of the virtual object. In some embodiments, a clearing control is displayed in the setting control. The first duration indicated by the setting operation may be cleared in response to a trigger operation based on the clearing control.

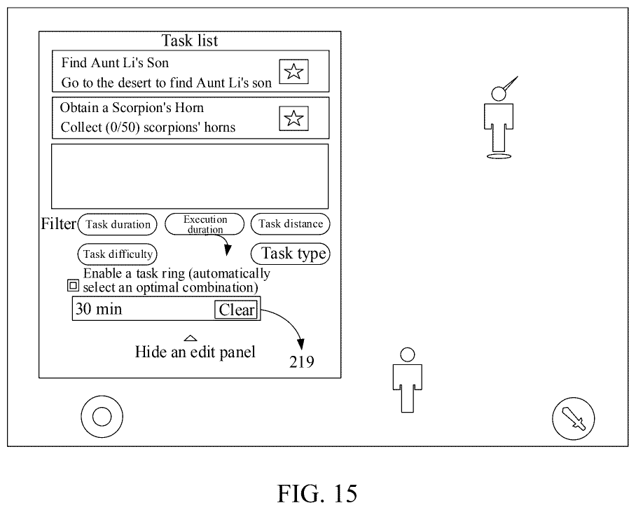

For example, refer to FIG. 15. FIG. 15 is a schematic diagram showing a task filtering interface according to an embodiment of this application. Based on a setting control 219, in response to a setting operation for an execution duration of a virtual object, the execution duration of the virtual object is set to 30 min (i.e., a first duration). In response to a trigger operation based on a clearing control, 30 min may be cleared (not shown in FIG. 15).

A task route constructed based on a third quantity of to-be-executed tasks is displayed in response to a trigger operation on the combined task control. The third quantity of to-be-executed tasks are obtained by filtering the first quantity of to-be-executed tasks based on the first duration. A sum of durations of the third quantity of to-be-executed tasks is less than or equal to the first duration. The third quantity may be equal to the second quantity, or may not be equal to the second quantity. In some embodiments, the third quantity of to-be-executed tasks may be sorted based on a sorting element, and may be set according to an actual use requirement of the user.

By setting the first duration, to-be-executed tasks can be further filtered, so that a sum of durations of the to-be-executed tasks is less than or equal to the first duration. In a subsequent task execution process, only the to-be-executed task corresponding to the first duration may be executed, thereby facilitating proper scheduling by the user.

In some embodiments, for different users, execution durations of to-be-executed tasks are different. To further assist in proper scheduling by a user, each time the user controls a virtual object to execute any one of a second quantity of to-be-executed tasks, the duration of the to-be-executed task may be subtracted from the first duration, to obtain a remaining duration. Then, the to-be-executed task may be increased or reduced in real time according to the remaining duration. The remaining duration is a difference between the first duration and the duration of the to-be-executed task that has been executed. In this way, only the to-be-executed task corresponding to the first duration may be executed, thereby further facilitating proper scheduling by the user.

In some embodiments, in response to a trigger operation on the combined task control, a task route obtained by filtering the to-be-executed tasks based on the route distance is displayed. The task distance is a route distance between a current position of the virtual object and a task point of the to-be-executed task. The task route is constructed based on the task distance and the third quantity. The third quantity of to-be-executed tasks are obtained by filtering the first quantity of to-be-executed tasks.

For example, refer to FIG. 14 and FIG. 15. Four to-be-executed tasks are displayed in FIG. 14. In FIG. 15, an execution duration of a virtual object is set to 30 min, and a sum of durations of a candidate task named “Find Aunt Li's Son” and a candidate task named “Obtain a Scorpion's Horn” is less than 30 min. The candidate task named “Find Aunt Li's Son” and the candidate task named “Obtain a Scorpion's Horn” are sorted based on a route distance between a current position of a virtual object and a task point of a to-be-executed task, to obtain a sorting order in which the candidate task named “Find Aunt Li's Son” precedes the candidate task named “Obtain a Scorpion's Horn.”

The task route is moving from the current position of the virtual object to a task point of the candidate task named “Find Aunt Li's Son,” and then moving from the task point of the candidate task named “Find Aunt Li's Son” to a task point of the candidate task named “Obtain a Scorpion's Horn.” In this way, it is convenient for proper scheduling by the user, and time for the user to find a task point of a to-be-executed task can also be shortened, thereby improving efficiency of executing the to-be-executed task. Moreover, it is convenient for the user to experience a plot corresponding to a complete to-be-executed task in a limited time.

In some embodiments, after a task route is displayed, a plurality of task routes are provided. Different task routes correspond to different sorting elements. The to-be-executed tasks are sorted based on the corresponding sorting elements in the task routes.

The sorting element includes a duration of the to-be-executed task, a route distance between a current position of the virtual object and a task point of the to-be-executed task, a difficulty of the to-be-executed task, a type of the to-be-executed task, and a priority of the to-be-executed task. For example, there may be two task routes: task route 1 and task route 2. Task route 1 is obtained by sorting based on the duration of to-be-executed task. Task route 2 is obtained by sorting based on the route distance between the current position of the virtual object and the task point of the to-be-executed task.

In response to a selection operation for a first task route, the first task route is determined as a task route of a to-be-executed task to be executed by the virtual object. To be specific, the first task route is determined as the task route of the to-be-executed task to be executed by the virtual object. The virtual object may sequentially execute the to-be-executed tasks based on the first task route. In this way, it is further convenient for the virtual object to execute the to-be-executed task.

For example, the first task route is task route 2. Task route 2 is obtained by sorting based on the route distance between the current position of the virtual object and the task point of the to-be-executed task. The virtual object may sequentially execute the to-be-executed tasks based on task route 2.

In a case that the to-be-executed tasks are sequentially executed based on the route distance between the current position of the virtual object and the task point of the to-be-executed task, the user does not need to view a map to find a position of each to-be-executed task, so that time for the user to control the virtual object to find the task point of the to-be-executed task can also be shortened, thereby improving efficiency of executing the to-be-executed task.

In some embodiments, in the presence of a plurality of to-be-executed tasks, the plurality of to-be-executed tasks are sorted based on a sorting element to obtain a third to-be-executed task sequence. A task execution control for the third to-be-executed task sequence is displayed. A second movement picture is displayed in the virtual scene in response to a trigger operation on the task execution control. The second movement picture shows that the virtual object moves from a current position to a task point of a second to-be-executed task. The second to-be-executed task is a first to-be-executed task in a third to-be-executed task sequence. The third to-be-executed task sequence is obtained by sorting a plurality of to-be-executed tasks based on a sorting element. In this way, the user only needs to trigger the task execution control to automatically move the virtual object to the task point.

In some embodiments, in response to a trigger operation on the task execution control, an execution route of a first to-be-executed task may be displayed in the virtual scene. In response to a control operation performed on the movement control by the user, a fifth movement picture for controlling the virtual object to move from a current position to a task point of a second to-be-executed task is displayed in the virtual scene. In this way, the execution route of the first to-be-executed task can guide the user to control the virtual object to move to the task point, thereby improving interaction experience.

In some embodiments, in response to a trigger operation on the task execution control, the task execution control may correspond to the combined task control. The terminal may transmit the task execution instruction for executing the third to-be-executed task sequence to the server. The server may generate a second control parameter for the virtual object, and transmit the second control parameter to the terminal. The terminal may execute the second control parameter, to display a picture in which the virtual object moves from a current position to a task point of the second to-be-executed task in the virtual scene. In this way, the virtual object can automatically move to the task point without an operation performed by the user.

In some embodiments, the sorting element is a route distance, and the route distance is a route distance between a current position of the virtual object and a task point of the to-be-executed task. After the second movement picture is displayed, the virtual object may be controlled to continue to fulfill the second to-be-executed task in a case that the virtual object does not fulfill the second to-be-executed task.

The route distance and a fourth to-be-executed task sequence are displayed in a case that the virtual object fulfills the second to-be-executed task. The fourth to-be-executed task sequence is obtained by re-sorting a plurality of to-be-executed tasks other than the second to-be-executed task. The fourth to-be-executed task sequence does not include the to-be-executed task fulfilled by the virtual object.

Each time the virtual object fulfills a to-be-executed task, a route distance may be displayed. The route distance is a route distance based on a current position of the virtual object and a task point of the to-be-executed task. Each time the virtual object fulfills a to-be-executed task, an updated to-be-executed task sequence, namely a fourth to-be-executed task sequence, may be displayed.

The fourth to-be-executed task sequence is obtained by re-sorting again to-be-executed tasks that are not fulfilled by the virtual object. In a case that the virtual scene needs to be redirected, each time a to-be-executed task is executed, a to-be-executed task having a minimum route distance from the current position may be re-determined according to the current position of the virtual object, so that the to-be-executed task having the minimum route distance from the current position may be executed, thereby improving task execution efficiency.

After the fourth to-be-executed task sequence is obtained, a third movement picture may be displayed in the virtual scene. The third movement picture is a picture in which the virtual object moves from a current position to a task point of a third to-be-executed task. The third to-be-executed task is a first to-be-executed task in the fourth to-be-executed task sequence.

To be specific, each time a to-be-executed task having a minimum route distance from the current position is re-determined according to the current position of the virtual object, the to-be-executed task closest to the current position may be executed. In this way, time for the user to find the task point of the to-be-executed task can be shortened, thereby improving efficiency of executing the to-be-executed task.

In some embodiments, in the presence of a plurality of to-be-executed tasks, based on a preset display style during the execution of a fourth to-be-executed task by the virtual object, the fourth to-be-executed task executed by the virtual object is identified after a to-be-executed task is displayed. The fourth to-be-executed task is any one of the to-be-executed tasks.

The display style may be a fifth display style. The fifth display style may be a preset color, a preset font, a preset identifier, or the like. This is not limited herein. In this way, the user can more intuitively learn the fourth to-be-executed task executed by the virtual object.

In some embodiments, a to-be-executed task executed by the virtual object in a task list may be identified by using the fifth display style. In some embodiments, a to-be-executed task executed by the virtual object in a task route may be identified by using the fifth display style. In this way, the user can more intuitively learn the fourth to-be-executed task executed by the virtual object.

In some embodiments, “Hide an edit panel” is displayed on the task filtering interface. For a filtering element, an input region of the filtering element, a sorting element, a combined task control, a setting control, and the like displayed on the task filtering interface, a corresponding operation may not be triggered after clicking/tapping by the user, and a corresponding edit page, namely the edit panel, is displayed instead. The user may edit at least one of the filtering element, the input region of the filtering element, the sorting element, a task ring control, or the setting control according to an actual use requirement. In response to a triggering operation for “Hide an edit panel,” an instruction corresponding to at least one of the filtering element, the input region of the filtering element, the sorting element, or the task ring control may be obtained, so as to display content of the response.

For example, for the task filtering interface, the sorting element may be set as a route distance between the current position of the virtual object and the task point of the to-be-executed task. An execution duration is set in the setting control. In response to a trigger operation for “Hide an edit panel,” a to-be-executed task sorted based on the route distance between the current position of the virtual object and the task point of the to-be-executed task may be displayed, where a sum of durations is less than the execution duration. In this way, processes of task filtering and task sorting do not need to be performed gradually, and task filtering and task sorting may be implemented by using one trigger operation.

In some embodiments, after a to-be-executed task is displayed, the virtual object may be controlled to obtain a second virtual resource. The second virtual resource may be a prop for changing a status of the virtual object, experience for changing a level of the virtual object, an item for the virtual object to purchase a prop, or the like.

For example, in a case that the virtual object fulfills the to-be-executed task, the virtual object may obtain a first virtual resource (i.e., the second virtual resource). For another example, the virtual object may obtain the second virtual resource in a form of exchanging an item with another virtual object.

In a case that the virtual object obtains the second virtual resource, because the second virtual resource is associated with the difficulty of the to-be-executed task and the duration of the to-be-executed task, a re-filtered to-be-executed task may be displayed. The re-filtered to-be-executed task is obtained by filtering a plurality of candidate tasks based on a filtering element associated with the second virtual resource.

To be specific, the to-be-executed task obtained by re-filtering the candidate tasks based on one or more of the task difficulty, the task duration, and the execution duration may be displayed. In this way, accuracy of filtering tasks can be improved.

In some embodiments, when the virtual object moves from the current position to the task point of the to-be-executed task, if the virtual object obtains a new candidate task, the candidate task may be updated to obtain an updated candidate task. After executing the to-be-executed task, the user may re-filter the updated candidate task to obtain an updated to-be-executed task. In this way, accuracy of filtering tasks can be improved.

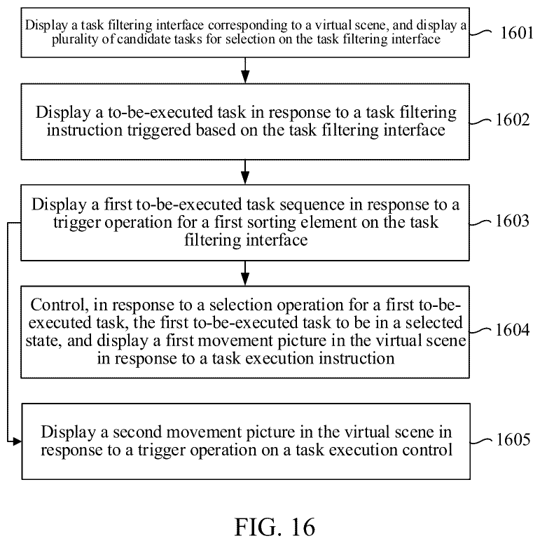

The following describes an exemplary application of a task filtering method provided in an embodiment of this application in an actual application scene. Refer to FIG. 16. FIG. 16 is a schematic flowchart of a task filtering method according to an embodiment of this application.

In operation 1601, a task filtering interface corresponding to a virtual scene is displayed, and a plurality of candidate tasks for selection are displayed on the task filtering interface.

For each candidate task, task information of the candidate task may be displayed. Refer to descriptions corresponding to the task information of the candidate task. Details are not described herein again.

In operation 1602, a to-be-executed task is displayed in response to a task filtering instruction triggered based on the task filtering interface.

Operation 1602 is consistent with operation 102 shown in FIG. 3. Refer to corresponding descriptions of operation 102. In a case that the to-be-executed task is displayed, the task information of the to-be-executed task and recommendation information of the to-be-executed task may further be displayed. For content, refer to the descriptions of the task information of the to-be-executed task and the recommendation information of the to-be-executed task. Details are not described herein again.

After operation 1602 is performed, to be specific, after the to-be-executed task obtained by filtering the plurality of candidate tasks based on at least one filtering element is displayed, operation 1603, operation 1604, or operation 1605 may be performed. Only execution of 1603 is shown in FIG. 16.

In operation 1603, a first to-be-executed task sequence is displayed in response to a trigger operation for a first sorting element on the task filtering interface.

The first to-be-executed task sequence is obtained by sorting to-be-executed tasks based on the first sorting element. Operation 1603 may be implemented by using any one of a first sorting manner to a fifth sorting manner. Refer to descriptions corresponding to the first sorting manner to the fifth sorting manner. Details are not described herein again. After operation 1603 is performed, to be specific, after the to-be-executed tasks are sorted based on the first sorting element, operation 1064 or operation 1065 may be performed.

In operation 1604, in response to a selection operation for a first to-be-executed task, the first to-be-executed task is controlled to be in a selected state, and a first movement picture is displayed in the virtual scene in response to a task execution instruction.

For operation 1604, the first movement picture is a picture in which a virtual object moves to a task point corresponding to the first to-be-executed task.

In operation 1605, a second movement picture is displayed in the virtual scene in response to a trigger operation on a task execution control.

For operation 1605, the second movement picture is a picture in which the virtual object moves from a current position to a task point of a second to-be-executed task. In some embodiments, the task execution control may be a combined task control. To be specific, in response to a trigger operation on the combined task control, a route distance may be displayed, and the second movement picture may be displayed.

In the task filtering method provided in an embodiment of this application, tasks can be filtered and sorted, so that a to-be-executed task is determined based on the filtered tasks or based on the filtered and sorted tasks. A user does not need to determine a to-be-executed task after viewing all tasks, thereby improving efficiency of determining the to-be-executed task by the user, and improving efficiency of human-computer interaction.

In the task filtering method provided in an embodiment of this application, a function for executing a plurality of to-be-executed tasks may be enabled, so that the user can be guided to control a virtual object to execute the tasks in sequence, and the user does not need to frequently click/tap to select a task to be executed, thereby improving task execution efficiency.

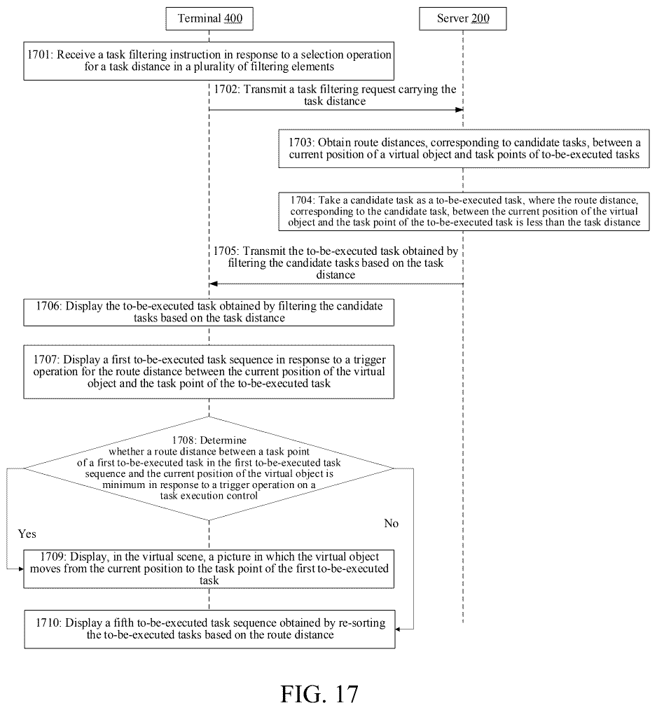

To further facilitate understanding of the task filtering method provided in an embodiment of this application, refer to FIG. 17. FIG. 17 is a schematic flowchart of a task filtering method according to an embodiment of this application. The task filtering method provided in an embodiment of this application is described below by using an example with reference to FIG. 17.

In operation 1701, a terminal 400 receives a task filtering instruction in response to a selection operation for a task distance in a plurality of filtering elements.

In operation 1702, the terminal 400 transmits a task filtering request carrying the task distance to a server 200.

In operation 1703, the server 200 obtains route distances, corresponding to candidate tasks, between a current position of a virtual object and task points of to-be-executed tasks.

In some embodiments, the server 200 may obtain the candidate tasks based on a virtual object identifier corresponding to the task filtering request, and then perform operation 1703. In some embodiments, when transmitting the task filtering request, the terminal 400 may transmit the route distances, corresponding to the candidate tasks, between the current position of the virtual object and the task points of the to-be-executed tasks to the server 200.

In operation 1704, the server 200 takes a candidate task as a to-be-executed task, where the route distance, corresponding to the candidate task, between the current position of the virtual object and the task point of the to-be-executed task is less than the task distance.

In operation 1705, the server 200 transmits the to-be-executed task obtained by filtering the candidate tasks based on the task distance to the terminal 400.

In operation 1706, the terminal 400 displays the to-be-executed task obtained by filtering the candidate tasks based on the task distance.

In operation 1707, the terminal 400 displays a first to-be-executed task sequence in response to a trigger operation for the route distance between the current position of the virtual object and the task point of the to-be-executed task.

The first to-be-executed task sequence is obtained by sorting the to-be-executed tasks based on the route distances between the current position of the virtual object and the task points of the to-be-executed tasks.

In some embodiments, in response to a trigger operation for a route between the current position of the virtual object and the task points of the to-be-executed tasks, the terminal 400 may transmit a sorting request carrying the route distances between the current position of the virtual object and the task points of the to-be-executed tasks to the server 200.

For each to-be-executed task, the server 200 may determine whether a route distance corresponding to a to-be-executed task is less than a route distance corresponding to another to-be-executed task. The route distance corresponding to the to-be-executed task is a route distance between the current position of the virtual object and a task point of the to-be-executed task. The route distance corresponding to the another to-be-executed task is a route distance between the current position of the virtual object and a task point of the another to-be-executed task.

In a case that the route distance corresponding to the to-be-executed task is less than the route distance corresponding to the another to-be-executed task, the to-be-executed task may precede the another to-be-executed task. In a case that the route distance corresponding to the to-be-executed task is greater than or equal to the route distance corresponding to the another to-be-executed task, the to-be-executed task may follow the another to-be-executed task, so that the to-be-executed tasks in a route distance less than the task distance may be sorted in ascending order of the route distances, to obtain the first to-be-executed task sequence.

Then, the server 200 may transmit the first to-be-executed task sequence to the terminal 400. The terminal 400 may display the first to-be-executed task sequence. The first to-be-executed task sequence is obtained by sorting the route distances in ascending order (not shown in FIG. 17). The first to-be-executed task sequence may be consistent with a third to-be-executed task sequence.

In operation 1708, the terminal 400 determines whether a route distance between a task point of a first to-be-executed task in the first to-be-executed task sequence and the current position of the virtual object is minimum in response to a trigger operation on a task execution control.

In a case that the route distance between the task point of the first to-be-executed task in the first to-be-executed task sequence and the current position of the virtual object is minimum, operation 1709 is performed. In a case that the route distance between the task point of the first to-be-executed task in the first to-be-executed task sequence and the current position of the virtual object is not minimum, operation 1710 is performed.

In operation 1709, the terminal 400 displays, in the virtual scene, a picture in which the virtual object moves from the current position to the task point of the first to-be-executed task.

In operation 1710, the terminal 400 displays a fifth to-be-executed task sequence obtained by re-sorting the to-be-executed tasks based on the route distance.

For operation 1710, the fifth to-be-executed task sequence may be consistent with the first to-be-executed task sequence. After operation 1710, operation 1708 may be performed again, and may end until the virtual object executes a to-be-executed task corresponding to the fifth to-be-executed task sequence (not shown in FIG. 17).

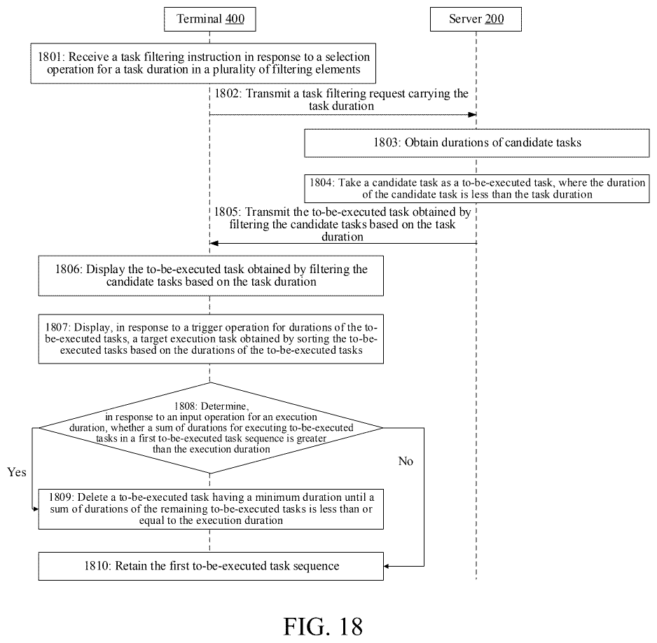

To further facilitate understanding of the task filtering method provided in an embodiment of this application, refer to FIG. 18. FIG. 18 is a schematic flowchart of a task filtering method according to an embodiment of this application. The task filtering method provided in an embodiment of this application is described below by using an example with reference to FIG. 18.

In operation 1801, a terminal 400 receives a task filtering instruction in response to a selection operation for a task duration in a plurality of filtering elements.

In operation 1802, the terminal 400 transmits a task filtering request carrying the task duration to a server 200.

In operation 1803, the server 200 obtains durations of candidate tasks.

In some embodiments, the server 200 may obtain the candidate tasks based on a virtual object identifier corresponding to the task filtering request, and then perform operation 1803. In some embodiments, when transmitting the task filtering request, the terminal 400 may transmit the durations of the candidate tasks to the server 200.

In operation 1804, the server 200 takes a candidate task as a to-be-executed task, where the duration of the candidate task is less than the task duration.

In operation 1805, the server 200 transmits the to-be-executed task obtained by filtering the candidate tasks based on the task duration to the terminal 400.

In operation 1806, the terminal 400 displays the to-be-executed task obtained by filtering the candidate tasks based on the task duration.

In operation 1807, the terminal 400 displays a first to-be-executed task sequence in response to a trigger operation for durations of the to-be-executed tasks.

The first to-be-executed task sequence is obtained by sorting the to-be-executed tasks based on the durations of the to-be-executed tasks. In some embodiments, in response to a trigger operation for the durations of the to-be-executed tasks, the terminal 400 may transmit a sorting request carrying the durations of the to-be-executed tasks to the server 200. For each to-be-executed task, the server 200 may determine whether a duration of the to-be-executed task is less than a duration of another to-be-executed task.

In a case that the duration of the to-be-executed task is less than the duration of the another to-be-executed task, the to-be-executed task may precede the another to-be-executed task. In a case that the duration of the to-be-executed task is not less than the duration of the another to-be-executed task, the to-be-executed task may follow the another to-be-executed task, so that the to-be-executed tasks having an execution duration less than the task duration may be sorted in ascending order of the durations of the to-be-executed tasks, to obtain the first to-be-executed task sequence.

Then, the server 200 may transmit the first to-be-executed task sequence to the terminal 400. The terminal 400 may display the first to-be-executed task sequence. The first to-be-executed task sequence is obtained by sorting in ascending order of the durations of the to-be-executed tasks (not shown in FIG. 18).

In operation 1808, the terminal 400 determines, in response to an input operation for an execution duration, whether a sum of durations for executing to-be-executed tasks in a first to-be-executed task sequence is greater than the execution duration.

In a case that the sum of durations for executing the to-be-executed tasks in the first to-be-executed task sequence is greater than the execution duration, operation 1809 is performed. In a case that the sum of durations for executing the to-be-executed tasks in the first to-be-executed task sequence is less than or equal to the execution duration, operation 1810 is performed.

In operation 1809, the terminal 400 deletes a to-be-executed task having a minimum duration until a sum of durations of the remaining to-be-executed tasks is less than or equal to the execution duration.

In operation 1810, the terminal 400 retains the first to-be-executed task sequence.

After operation 1810, the to-be-executed tasks in the first to-be-executed task sequence may be executed. Refer to the foregoing descriptions for executing the to-be-executed task. Details are not described herein again.

The following continues to describe an exemplary structure in which the task filtering apparatus 455 provided in an embodiment of this application is implemented as a software module. In some embodiments, as shown in FIG. 2, the software module in the task filtering apparatus 455 stored in the memory 450 may include:
a display module 4551, configured to display a plurality of candidate tasks for selection on a task filtering interface of a virtual scene; and
a response module 4552, configured to display a to-be-executed task in response to a task filtering instruction triggered based on the task filtering interface, the to-be-executed task being obtained by filtering the plurality of candidate tasks based on at least one filtering element, and the to-be-executed task being configured for being executed by a virtual object in the virtual scene to obtain a first virtual resource.

In some embodiments, the display module 4551 is further configured to display a plurality of filtering elements on the task filtering interface.

The response module 4552 is further configured to receive the task filtering instruction in response to a selection operation on a first filtering element.

The response module 4552 is further configured to display, in response to the task filtering instruction triggered based on the task filtering interface, a to-be-executed task obtained by filtering based on the first filtering element.

In some embodiments, the display module 4551 is further configured to display an input region of at least one filtering element on the task filtering interface, and display, in the input region, input prompt information for the input region.

The response module 4552 is further configured to receive, based on the input prompt information, the task filtering instruction in response to a parameter input operation, triggered in a first input region, on a second filtering element, the task filtering instruction carrying a parameter of the second filtering element.

The response module 4552 is further configured to display, in response to the task filtering instruction triggered based on the task filtering interface, a to-be-executed task obtained by filtering based on the parameter of the second filtering element.

In some embodiments, the display module 4551 is further configured to perform one of the following:
displaying, in a case that the filtering element is a task duration, a to-be-executed task obtained by filtering based on the task duration, the task duration being configured for limiting a duration of each to-be-executed task;
displaying, in a case that the filtering element is an execution duration, a to-be-executed task set obtained by filtering based on the execution duration, the to-be-executed task set including at least one to-be-executed task, and the execution duration being configured for indicating a sum of durations of the to-be-executed tasks in each to-be-executed task set;
displaying, in a case that the filtering element is a task distance, a to-be-executed task obtained by filtering based on the task distance, the task distance being configured for indicating a distance between a current position of the virtual object and a task point of the to-be-executed task;
displaying, in a case that the filtering element is a task difficulty, a to-be-executed task obtained by filtering based on the task difficulty, the task difficulty being configured for limiting a difficulty of the to-be-executed task; and
displaying, in a case that the filtering element is a task type, a to-be-executed task obtained by filtering based on the task type, the task type being configured for indicating a type of the to-be-executed task.

In some embodiments, the filtering element is the task distance. The display module 4551 is further configured to display a plurality of distance range options, different distance range options corresponding to different distance ranges.

The response module 4552 is further configured to display, in response to a selection instruction for a first distance range option, a to-be-executed task obtained by filtering based on a first distance range, the first distance range corresponding to the first distance range option, and a distance between the task point and the current position of the virtual object being within the first distance range.

In some embodiments, the display module 4551 is further configured to display a first distance range corresponding to the first distance range option before displaying, in response to a selection instruction for a first distance range option, a to-be-executed task obtained by filtering based on a first distance range.

The response module 4552 is further configured to: display, in response to an adjustment instruction for the first distance range, a second distance range corresponding to the first distance range option, the second distance range being obtained by adjusting the first distance range based on the adjustment instruction; and display, in response to a selection instruction for the first distance range option, a to-be-executed task obtained by filtering based on the second distance range.

In some embodiments, at least one execution route is present for each to-be-executed task, and the execution route is a route from a current position of the virtual object to a corresponding task point.

The display module 4551 is further configured to display a plurality of difficulty controls after displaying a to-be-executed task, different difficulty controls corresponding to different difficulties of the execution routes.

The response module 4552 is further configured to display a first execution route in response to a trigger operation on a first difficulty control, the first execution route being obtained by filtering based on a difficulty corresponding to the first difficulty control.

In some embodiments, in the presence of a plurality of to-be-executed tasks, the display module 4551 is further configured to display at least one sorting control on the task filtering interface, each sorting control corresponding to a sorting element, and the sorting element being configured for sorting the to-be-executed tasks.

The response module 4552 is further configured to display, after displaying a to-be-executed task, a first to-be-executed task sequence in response to a trigger operation on a first sorting control on the task filtering interface, the first sorting control corresponding to a first sorting element, and the first to-be-executed task sequence being obtained by sorting the plurality of to-be-executed tasks based on the first sorting element.

In some embodiments, the response module 4552 is further configured to display, after displaying a first to-be-executed task sequence, a second to-be-executed task sequence in response to an adjustment instruction for the first to-be-executed task sequence, the second to-be-executed task sequence being obtained by adjusting sorting of the plurality of to-be-executed tasks in the first to-be-executed task sequence.

In some embodiments, the response module 4552 is further configured to: control, in response to a selection operation for a first to-be-executed task among the to-be-executed tasks, the first to-be-executed task to be in a selected state after displaying a to-be-executed task; and display a first movement picture in the virtual scene in response to a task execution instruction, the first movement picture being a picture in which the virtual object moves to a task point corresponding to the first to-be-executed task.

In some embodiments, the response module 4552 is further configured to: display a plurality of execution routes in response to a task execution instruction, the execution routes being routes from a current position of the virtual object to a task point corresponding to the first to-be-executed task; and display a first movement picture in the virtual scene in response to a selection operation for a second execution route, the first movement picture being a picture in which the virtual object moves to the task point based on the second execution route, and the second execution route belonging to the plurality of execution routes.

In some embodiments, the display module 4551 is further configured to display task information of the to-be-executed task, the task information including one or more of: a duration of the to-be-executed task, a type of the to-be-executed task, a route distance between a current position of the virtual object and a task point of the to-be-executed task, a difficulty of the to-be-executed task, and a priority of the to-be-executed task.

In some embodiments, the display module 4551 is further configured to display, in the presence of a plurality of to-be-executed tasks, recommendation information of the to-be-executed tasks, the recommendation information being configured for guiding selection of the to-be-executed task, and the recommendation information including one or more of a recommendation degree and a recommended prop for the to-be-executed task.

In some embodiments, the display module 4551 is further configured to display, after displaying a to-be-executed task, a combined task control when a quantity of to-be-executed tasks is a first quantity and the first quantity is greater than 1.

The response module 4552 is further configured to display, in response to a trigger operation on the combined task control, a task route constructed based on a second quantity of to-be-executed tasks, the to-be-executed tasks serving as route nodes of the task route, the task route being configured for guiding the virtual object to sequentially fulfill the to-be-executed tasks based on the route nodes, and the second quantity being less than or equal to the first quantity.

In some embodiments, the response module 4552 is further configured to: provide, after displaying a task route constructed based on a second quantity of to-be-executed tasks, a plurality of task routes, different task routes corresponding to different sorting elements, and the to-be-executed tasks being sorted based on the corresponding sorting elements in the task routes; and determine, in response to a selection operation for a first task route, the first task route as a task route of a to-be-executed task to be executed by the virtual object.

In some embodiments, the display module 4551 is further configured to display a setting control on the task filtering interface, the setting control being configured to set an execution duration.

The response module 4552 is further configured to set, based on the setting control in response to a setting operation for the execution duration of the virtual object, the execution duration of the virtual object to a first duration indicated by the setting operation.

The response module 4552 is further configured to display, in response to a trigger operation on the combined task control, a task route constructed based on a third quantity of to-be-executed tasks, a sum of durations of the third quantity of to-be-executed tasks being less than or equal to the first duration.

In some embodiments, the response module 4552 is further configured to display, in response to a trigger operation on the combined task control, a task route obtained by filtering a to-be-executed task based on a route distance, the route distance being a distance between a current position of the virtual object and a task point of the to-be-executed task, and the task route being constructed based on the route distance and a third quantity of to-be-executed tasks.

In some embodiments, the display module 4551 is further configured to display, after displaying a to-be-executed task, a task execution control for a third to-be-executed task sequence in the presence of a plurality of to-be-executed tasks, the third to-be-executed task sequence being obtained by sorting the plurality of to-be-executed tasks based on a sorting element.

The response module 4552 is further configured to display a second movement picture in the virtual scene in response to a trigger operation on the task execution control, the second movement picture being a picture in which the virtual object moves from a current position to a task point of a second to-be-executed task, and the second to-be-executed task being a first to-be-executed task in the third to-be-executed task sequence.

In some embodiments, the sorting element is a route distance, and the route distance is a distance between a current position of the virtual object and a task point of the to-be-executed task.

The display module 4551 is further configured to: display, after displaying a second movement picture in the virtual scene, the route distance and a fourth to-be-executed task sequence in a case that the virtual object fulfills the second to-be-executed task, the fourth to-be-executed task sequence being obtained by re-sorting a plurality of to-be-executed tasks other than the second to-be-executed task, and the fourth to-be-executed task sequence not including the to-be-executed task fulfilled by the virtual object; and display a third movement picture in the virtual scene, the third movement picture being a picture in which the virtual object moves from a current position to a task point of a third to-be-executed task, and the third to-be-executed task being a first to-be-executed task in the fourth to-be-executed task sequence.

In some embodiments, in the presence of a plurality of to-be-executed tasks, the display module 4551 is further configured to identify, based on a preset display style during the execution of a fourth to-be-executed task by the virtual object, the fourth to-be-executed task executed by the virtual object after displaying a to-be-executed task, the fourth to-be-executed task being any one of the to-be-executed tasks.

In some embodiments, the display module 4551 is further configured to: control, after displaying a to-be-executed task, the virtual object to obtain a second virtual resource; and display a re-filtered to-be-executed task in a case that the virtual object obtains the second virtual resource, the re-filtered to-be-executed task being obtained by filtering the plurality of candidate tasks based on a filtering element associated with the second virtual resource.

An embodiment of this application provides a computer program product. The computer program product includes a computer program or computer-executable instructions. The computer program or the computer-executable instructions are stored in a computer-readable storage medium. A processor of an electronic device reads the computer-executable instructions from the computer-readable storage medium. The processor executes the computer-executable instructions, so that the electronic device performs the task filtering method provided in an embodiment of this application.

An embodiment of this application provides a computer-readable storage medium having computer-executable instructions stored therein. A computer program or the computer-executable instructions are stored therein. The computer program or the computer-executable instructions, when executed by a processor, cause the processor to perform the task filtering method provided in an embodiment of this application, for example, the task filtering method shown in FIG. 3A.

In some embodiments, the computer-readable storage medium may be a memory such as a RAM, a ROM, a flash memory, a magnetic surface memory, an optical disc, or a CD-ROM, or may be various devices including one or any combination of the memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

As an example, the computer-executable instructions may, but not necessarily, correspond to a file in a file system, and may be stored in a part of the file that stores other programs or data, for example, stored in one or more scripts in a hyper text markup language (HTML) document, stored in a single file dedicated to the program under discussion, or stored in a plurality of collaborative files (e.g., a file that stores one or more modules, subroutines, or code parts).

As an example, the computer-executable instructions may be deployed to be executed on one electronic device, or executed on a plurality of electronic devices located at one position, or executed on a plurality of electronic devices that are distributed in a plurality of positions and interconnected by a communication network.

In conclusion, in the embodiments of this application, tasks in a virtual scene can be filtered, to display a to-be-executed task obtained by filtering based on a filtering element, so that after executing the displayed to-be-executed task, a first virtual resource may be obtained by a virtual object, and the to-be-executed task is a filtered candidate task. To be specific, in the embodiments of this application, a manner of displaying candidate tasks can be changed. Compared with the related art, the manner of displaying candidate tasks can be increased. Moreover, interaction manners for task filtering are provided in the embodiments of this application. Compared with the related art, the diversity of the interaction manners can be increased.

In the embodiments of this application, the filtered to-be-executed tasks can be sorted. After the tasks are filtered or the tasks are filtered and sorted, a user may select a task to be executed more quickly. To be specific, efficiency of determining a task to be executed by the user is provided.

In the task filtering method provided in an embodiment of this application, a function for executing a plurality of to-be-executed tasks may be enabled, so that the user can be guided to control a virtual object to execute the tasks in sequence, and the user does not need to frequently click/tap to select a task to be executed, thereby improving task execution efficiency.

Moreover, in a case that the function for executing a plurality of to-be-executed tasks is enabled, an execution duration and a route distance are combined, thereby not only shortening time in which the user controls the virtual object to find a task point of a to-be-executed task and improving efficiency of executing the to-be-executed task, but also making it convenient for the user to make a proper schedule, to ensure that the user can experience a complete plot corresponding to the to-be-executed task within a limited time.

The foregoing descriptions are merely embodiments of this application, and are not intended to limit the scope of this disclosure. Any modification, equivalent replacement, or improvement made within the spirit and scope of this application fall within the scope of this disclosure.

What is claimed is:

1. A task filtering method, performed by an electronic device, comprising:
displaying a plurality of candidate tasks on a task filtering interface of a virtual scene; and
displaying one or more target tasks in response to a task filtering instruction triggered based on the task filtering interface, the one or more target tasks being obtained by filtering the plurality of candidate tasks based on at least one filtering element, and being configured for being executed by a virtual object in the virtual scene to obtain one or more virtual resources.

2. The method according to claim 1, further comprising:
displaying a filtering element on the task filtering interface; and
receiving the task filtering instruction in response to a selection operation on the filtering element;
wherein displaying the one or more target tasks includes:
displaying at least one of the one or more target tasks obtained by filtering based on the filtering element.

3. The method according to claim 1, further comprising:
displaying an input region of a filtering element on the task filtering interface, and displaying, in the input region, input prompt information for the input region; and
receiving, based on the input prompt information, the task filtering instruction in response to a parameter input operation of the filtering element triggered in the input region, the task filtering instruction carrying a parameter of the filtering element;
wherein displaying the one or more target tasks includes:
displaying at least one of the one or more target tasks obtained by filtering based on the parameter of the filtering element.

4. The method according to claim 1, wherein displaying the one or more target tasks includes one or more of:
displaying a first target task obtained by filtering based on a task duration as one of the at least one filtering element, the task duration being configured for limiting a duration of the first target task;
displaying a target task set obtained by filtering based on an execution duration as one of the at least one filtering element, the target task set including at least one second target task, and the execution duration indicating a sum of durations of the at least one second target task;
displaying a third target task obtained by filtering based on a task distance as one of the at least one filtering element, the task distance indicating a distance between a current position of the virtual object and a task point of the third target task;
displaying a fourth target task obtained by filtering based on a task difficulty as one of the at least one filtering element, the task difficulty limiting a difficulty of the fourth target task; and
displaying a fifth target task obtained by filtering based on a task type as one of the at least one filtering element, the task type indicating a type of the fifth target task.

5. The method according to claim 1, wherein:
the at least one filtering element includes a task distance;
displaying the one or more target tasks includes:
displaying a plurality of distance range options corresponding to a plurality of distance ranges, respectively; and
displaying, in response to a selection instruction for one distance range option of the plurality of distance range options, one target task obtained by filtering based on one distance range of the plurality of distance ranges that corresponds to the one distance range option, and
a distance between a current position of the virtual object and a task point of the one target task is within the one distance range.

6. The method according to claim 5,
wherein the one distance range is a first distance range;
the method further comprising, before displaying the one target task:
displaying the first distance range; and
displaying, in response to an adjustment instruction for the first distance range, a second distance range corresponding to the one distance range option, the second distance range being obtained by adjusting the first distance range based on the adjustment instruction;
wherein displaying the one target task includes:
displaying the one target task obtained by filtering based on the second distance range.

7. The method according to claim 1, further comprising, after displaying the one or more target tasks:
displaying a plurality of difficulty controls corresponding to different difficulties; and
displaying an execution route in response to a trigger operation on one difficulty control of the plurality of difficulty controls, the execution route being obtained by filtering based on a difficulty corresponding to the one difficulty control and being one of at least one execution route corresponding to one of the one or more target tasks, and each of the at least one execution route being a route from a current position of the virtual object to a corresponding task point.

8. The method according to claim 1,
wherein the one or more target tasks include a plurality of target tasks;
the method further comprising:
displaying, on the task filtering interface, at least one sorting control each corresponding to a sorting element for sorting the plurality of target tasks; and
after displaying the plurality of target tasks, displaying a target task sequence in response to a trigger operation on one sorting control of the at least one sorting control, the target task sequence being obtained by sorting the plurality of target tasks based on the sorting element corresponding to the one sorting control.

9. The method according to claim 8,
wherein the target task sequence is a first target task sequence;
the method further comprising, after displaying the first task sequence:
displaying a second target task sequence in response to an adjustment instruction for the first target task sequence, the second target task sequence being obtained by adjusting sorting of the plurality of target tasks in the first target task sequence.

10. The method according to claim 1, further comprising, after displaying the one or more target tasks:
controlling, in response to a selection operation for one target task of the one or more target tasks, the one target task to be in a selected state; and
displaying a movement picture in the virtual scene in response to a task execution instruction, the movement picture being a picture in which the virtual object moves to a task point corresponding to the one target task.

11. The method according to claim 10, wherein displaying the movement picture includes:
displaying a plurality of execution routes from a current position of the virtual object to the task point; and
displaying the movement picture in the virtual scene in response to a selection operation for one execution route of the plurality of execution routes, the movement picture being a picture in which the virtual object moves to the task point based on the one execution route.

12. The method according to claim 1, further comprising:
displaying task information of one target task of the one or more target tasks;
wherein the task information includes one or more of: a duration of the one target task, a type of the one target task, a distance between a current position of the virtual object and a task point of the one target task, a difficulty of the one target task, and a priority of the one target task.

13. The method according to claim 1,
wherein the one or more target tasks include a plurality target tasks;
the method further comprising:
displaying recommendation information of the plurality of target tasks;
wherein the recommendation information includes one or more of a recommendation degree and a recommended prop for each of the plurality of target tasks.

14. The method according to claim 1,
wherein the one or more target tasks include a first quantity of target tasks, the first quantity being greater than 1;
the method further comprising, after displaying the first quantity of target tasks:
displaying a combined task control; and
displaying, in response to a trigger operation on the combined task control, a task route constructed based on a second quantity of target tasks as route nodes of the task route, the task route guiding the virtual object to sequentially fulfill the second quantity of target tasks based on the route nodes.

15. The method according to claim 14,
wherein the task route is one of a plurality of task routes being displayed each corresponding to a sorting elements based on which the target tasks in the task route is sorted;
the method further comprising:
determining one task route of the plurality of task routes for execution by the virtual object in response to a selection operation for the one task route.

16. The method according to claim 14, further comprising:
displaying a setting control on the task filtering interface, the setting control being configured to set an execution duration of the virtual object; and
setting, based on the setting control and in response to a setting operation, the execution duration to a duration indicated by the setting operation;
wherein a sum of durations of the target tasks in the task route is less than or equal to the duration indicated by the setting operation.

17. The method according to claim 14, wherein the task route is obtained by filtering the plurality of target tasks based on a route distance of each of the plurality of target tasks, the route distance of one target task being a distance between a current position of the virtual object and a task point of the one task.

18. The method according to claim 1,
wherein the one or more target tasks include a plurality of target tasks;
the method further comprising, after displaying the plurality of target tasks:
displaying a task execution control for a target task sequence, the target task sequence being obtained by sorting the plurality of target tasks based on a sorting element; and
displaying a movement picture in the virtual scene in response to a trigger operation on the task execution control, the movement picture being a picture in which the virtual object moves from a current position to a task point of the first target task in the target task sequence.

19. An electronic device comprising:
a memory storing computer-executable instructions or a computer program; and
a processor configured to execute the computer-executable instructions or the computer program to:
display a plurality of candidate tasks on a task filtering interface of a virtual scene; and
display one or more target tasks in response to a task filtering instruction triggered based on the task filtering interface, the one or more target tasks being obtained by filtering the plurality of candidate tasks based on at least one filtering element, and being configured for being executed by a virtual object in the virtual scene to obtain one or more virtual resources.

20. A non-transitory computer-readable storage medium storing computer-executable instructions or a computer program that, when executed by a processor, causes an electronic device including the processor to:
display a plurality of candidate tasks on a task filtering interface of a virtual scene; and
display one or more target tasks in response to a task filtering instruction triggered based on the task filtering interface, the one or more target tasks being obtained by filtering the plurality of candidate tasks based on at least one filtering element, and being configured for being executed by a virtual object in the virtual scene to obtain one or more virtual resources.
